(19) United States
(12) Patent Application Publication
(10) Pub. No.: US 2026/0267808 A1
(43) Pub. Date: Sep. 10, 2026

(54) SYSTEMS, METHODS, APPARATUS, AND ARTICLES OF MANUFACTURE TO ENFORCE SECURITY THROUGH PHYSICAL MEMORY REGIONS

(71) Applicant: Openchip & Software Technologies S.L., Barcelona (ES)

(72) Inventors: Edgar Gonzàlez Pellicer, Girona (ES); Francesc Guim Bernat, Barcelona (ES); Akira Tsukamoto, Barcelona (ES)

(21) Appl. No.: 19/664,715

(22) Filed: Apr. 30, 2026

Related U.S. Application Data
(63) Continuation of application No. PCT/EP2025/078863, filed on Oct. 7, 2025.

(51) Int. Cl. G06F 12/14

(52) U.S. Cl. CPC G06F 12/1483; G06F 12/1433; G06F 12/1491

(57) ABSTRACT

Systems, apparatus, articles of manufacture, and methods are disclosed to enforce security through physical memory regions. An example apparatus includes memory including at least one region, a first integrated circuit (IC) coupled to the memory, and a second IC coupled to the memory. The example second IC is to, after successful attestation of at least one of first code or first data associated with a first region of the memory, adjust a first security level of the first region based on the at least one of the first code or the first data, and permit or deny an access request to the first region by the first IC based on (1) a type of the access request, (2) the first security level of the first region, and (3) a second security level of a second region in which second code is stored, the second code associated with the access request.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to data and code security enforcement and, more particularly, to systems, methods, apparatus, and articles of manufacture to enforce security through physical memory regions.

### BACKGROUND

Management architectures for compute devices enable users to observe and control devices for tasks such as performance monitoring (e.g., monitoring of processor utilization, memory utilization, operating temperature, etc.), power management (e.g., through clock frequency regulation, voltage regulation, etc.), service level assurance (e.g., through load balancing, resource activation/deactivation, etc.), and data privacy (e.g., access control, privilege enforcement, etc.), etc. Data privacy is a critical aspect of edge and data center deployments. Efforts to protect data include hardware assisted compute and memory security frameworks. Such hardware assisted compute and memory security frameworks include network cryptography, secure enclaves, and total memory encryption.

### BRIEF DESCRIPTION OF THE DRAWINGS

FIG. 1 is a block diagram of an example system including an example compute device that implements a multi-tier management architecture for security enforcement through physical memory regions.

FIG. 2 is a block diagram of the example compute chiplet included in the compute device of FIG. 1.

FIG. 3 is a block diagram of an example implementation of the physical memory management (PMM) circuitry of FIG. 1.

FIG. 4 is a flowchart representative of example machine-readable instructions and/or example operations that may be executed, instantiated, and/or performed by programmable circuitry to implement the PMM circuitry of FIGS. 1 and/or 3.

FIG. 5 is a flowchart representative of example machine-readable instructions and/or example operations that may be executed, instantiated, and/or performed by programmable circuitry to process a security level adjustment request.

FIG. 6 is a flowchart representative of example machine-readable instructions and/or example operations that may be executed, instantiated, and/or performed by programmable circuitry to process a memory access request.

FIG. 7 is a flowchart representative of example machine-readable instructions and/or example operations that may be executed, instantiated, and/or performed by programmable circuitry to configure one or more AI/ML models to process sensitive data and allocate protected memory to store the sensitive data.

FIG. 8 illustrates an example hardware arrangement of an example data center.

FIG. 9A illustrates an example arrangement of an example chip assembly of FIG. 8.

FIG. 9B illustrates an example arrangement of an example chip assembly of FIG. 8, adapted for high-performance computing applications.

FIG. 10 is a block diagram of an example processing platform including programmable circuitry structured to execute, instantiate, and/or perform the example machine-readable instructions and/or perform the example operations of FIGS. 4, 5, 6, and/or 7 to implement the PMM circuitry of FIG. 3 and/or the management chiplet of FIG. 1.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine-readable instructions of FIGS. 4, 5, 6, and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

As compute devices and software become more pervasive, the security of data and code is a primary concern for stakeholders (e.g., software developers, hardware developers, service providers, customers, end-users, etc.). In particular, as artificial intelligence (AI) is developed, stakeholders are concerned with retaining control and ownership over data to ensure safe and empowered adoption of AI technologies. For example, a user may want to control which data consumers can access data in order to comply with a regulation or law such as the General Data Protection Regulation (GDPR) in the European Union. Additionally or alternatively, a user may want to control which data consumer can access data in order to comply with a regulation or law such as the Health Insurance Portability and Accountability Act (HIPAA) in the United States, the Biometric Information Privacy Act (BIPA) in Illinois, and/or the California Consumer Privacy Act (CCPA) in California.

Additionally, as AI is developed, stakeholders are concerned with having hardware and software techniques that allow for the attestation of data objects used for training and AI models used for AI inferencing. In general, attestation refers to verification of the integrity and trustworthiness of a system, a device, software, or data. In the context of AI, attestation refers to verification of an AI model and/or data objects to be processed by the AI model by circuitry of a System-on-Chip (SoC) or chiplet that connects to an attestation service (remote or local) that can validate the AI model and/or the data objects. Many attestation services exist such as Intel Attestation Service (IAS), Microsoft Azure Attestation, Amazon Web Services (AWS) Nitro Attestation, Google Confidential Computing Attestation, and Trusted Platform Module (TPM) Remote Attestation, among others.

Many attestation services rely on secure enclaves. As used herein, a secure enclave is a secure execution environment that is isolated from other executable code (e.g., code executing on a main processor). A secure enclave may be implemented by software (e.g., one or more trusted execution environments (TEEs) such as container(s) and/or virtual machine(s) (VM(s))) executed from a private region of memory and/or as a physically separate hardware processor that executes code separate from the main processor. In a software-based secure enclave, access to the private region of memory is enforced by hardware components (e.g., the memory management unit) of a compute device. The terms secure enclave and TEE are used interchangeably. Secure enclaves allow applications to safely process data and/or perform operations within the secure enclave.

Principles to consider when developing hardware to satisfy the growing demand of AI technologies include sustainability, scalability, and security. For example, sustainability refers to the ability of technology (e.g., hardware and/or software) to reduce the energy footprint of AI. Scalability refers to the ability to use the technology (e.g., software and/or hardware) to solve increasingly larger problems, often by replicating elements in a commensurable way. One way to achieve scalability is to orchestrate distributed agents, each executing localized inference or decision-making. For example, as more AI models are executed on a platform, scalability refers to the ability of the platform to orchestrate distributed agents, each executing a localized instance of an AI model. Security refers to the ability of technology (e.g., hardware and/or software) to trace and control data. Security is particularly important in regulated domains such as healthcare and transportation.

As described above, security of data and code is a widely held concern for the broader adoption of AI technologies. Many technologies exist to aid data and code security. For example, network cryptography can be used to protect communication channels between two points (e.g., secure sockets layer (SSL) encryption, transport layer security (TLS) encryption, etc.). Also, secure enclaves can be used in conjunction with an attestation service to protect execution of particular processes. Other technologies to secure data and code include total memory encryption (TME). For example, TME encrypts all data passing to and from a central processor unit (CPU) including data on external memory busses of the CPU. An example of TME is multi-key TME (MKTME) which allows for multiple encryption keys to be used to encrypt different portions of memory with different encryption keys. As such, data encrypted with one encryption key can be securely stored in the same memory as data encrypted with another encryption key. TME protects data that is stored in non-volatile (e.g., persistent) memory and/or data that is stored in volatile memory.

While many technologies exist to aid data and code security, how the security of data and code is enforced at the hardware level is not as well developed. As described above, sustainability, scalability, and security are principles to consider when developing hardware to satisfy the growing demand of AI technologies. Examples disclosed herein address one or more of sustainability, scalability, and security. For example, systems, methods, apparatus, and articles of manufacture disclosed herein include a permission model that controls the access of code to data such that a core executing unprivileged code cannot access protected data even if system-level components in the core (e.g., firmware, the operating system (OS), etc.) become compromised. Examples disclosed herein allow a user to retain control and ownership over data. Additionally, examples disclosed herein provide hardware and/or software techniques for the attestation of data objects and/or AI models that are to process the data objects. The following introduces examples of computer hardware for permissions enforcement operations, applicable in programmable architectures such as chiplet-based processors, SoC circuitry, System-in-Package (SiP) or System-on-Package (SoP) circuitry, and/or any other modular packaging implementations of programmable circuitry regardless of the physical architecture and interconnection options selected for final implementation. The following hardware examples specifically provide systems, methods, apparatus, and articles of manufacture to enforce security through physical memory regions.

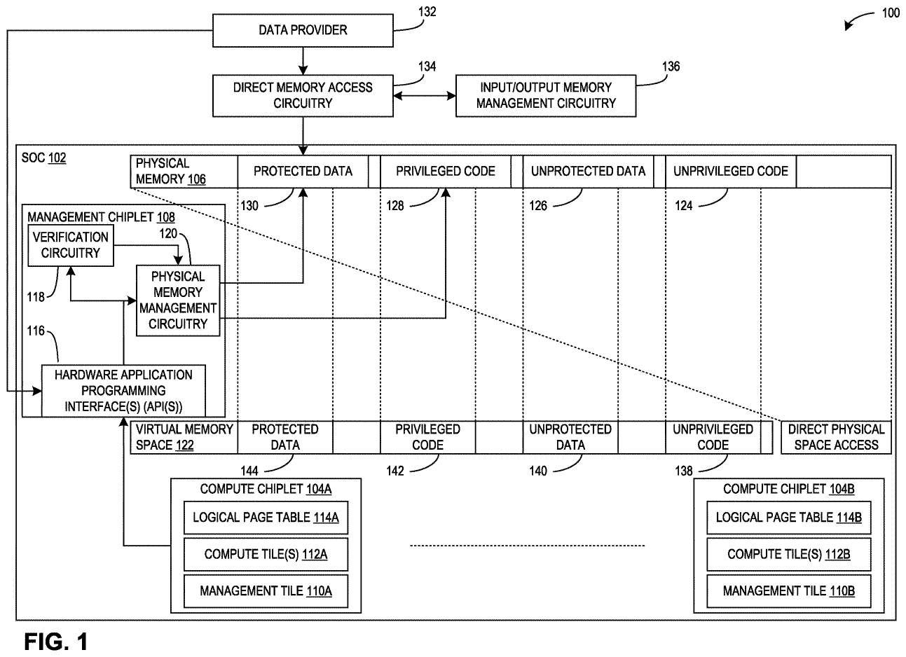

FIG. 1 is a block diagram of an example system 100 including an example compute device 102 that implements a multi-tier management architecture for security enforcement through physical memory regions. In the example of FIG. 1, the compute device 102 is depicted as an SoC device. However, the compute device 102 can be implemented by another type of compute device, such as an application specific integrated circuit (ASIC), a semiconductor device, a chip, etc., or another type of compute device. Furthermore, although one compute device 102 is illustrated in FIG. 1, the system 100 can include more compute devices similar to the compute device 102.

In the illustrated example of FIG. 1, the compute device 102 includes example compute chiplets 104A-B and example physical memory 106 coupled to the compute chiplets 104A-B. The compute device 102 of FIG. 1 also includes an example management chiplet 108 coupled to the compute chiplets 104A-B and the physical memory 106. In some examples, the physical memory 106 is implemented as a chiplet. Additionally or alternatively, the physical memory 106 is implemented as an attached memory. In the example of FIG. 1, the compute chiplets 104A-B include respective example management tiles 110A-B, respective example one or more compute tiles 112A-B, and respective example logical page tables 114A-B.

Although the compute device 102 is depicted as including two compute chiplets 104A-B, the compute device 102 can include fewer or more compute chiplets 104A-B. In some examples, the compute device 102 can include other chiplet(s) in addition to, or in the alternative to, the compute chiplets 104A-B. For example, the compute device 102 can include one or more memory chiplets (e.g., the physical memory 106), communication chiplets, etc. Also, such other chiplet(s) can also include respective management tile(s) similar to the management tiles 110A-B. Furthermore, the various chiplets 104A-B, 106, and 108 can be homogeneous (e.g., implemented by the same manufacturer) or heterogeneous (e.g., with two or more of the various chiplets 104A-B, 106, and 108 implemented by distinct manufacturers).

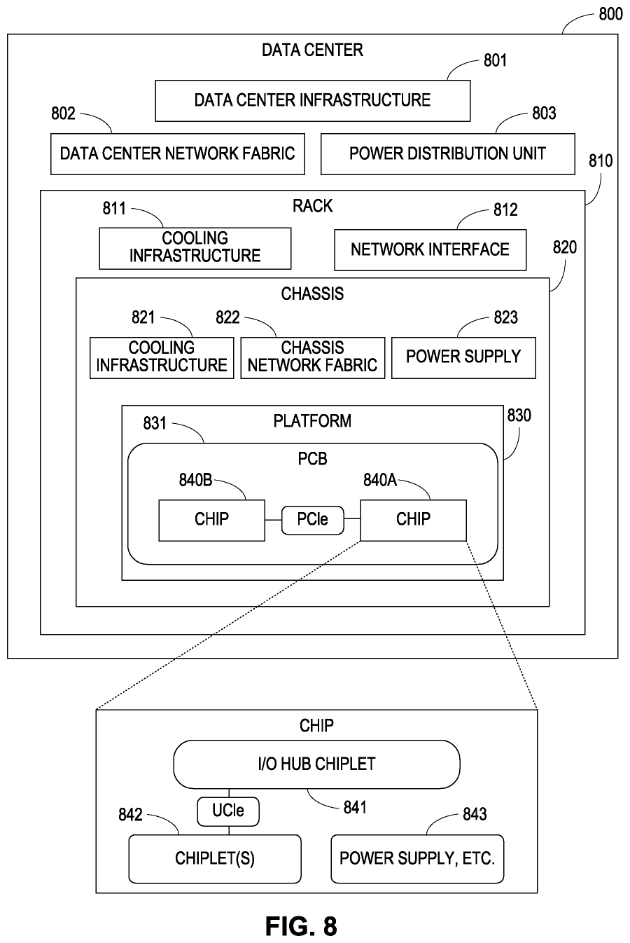

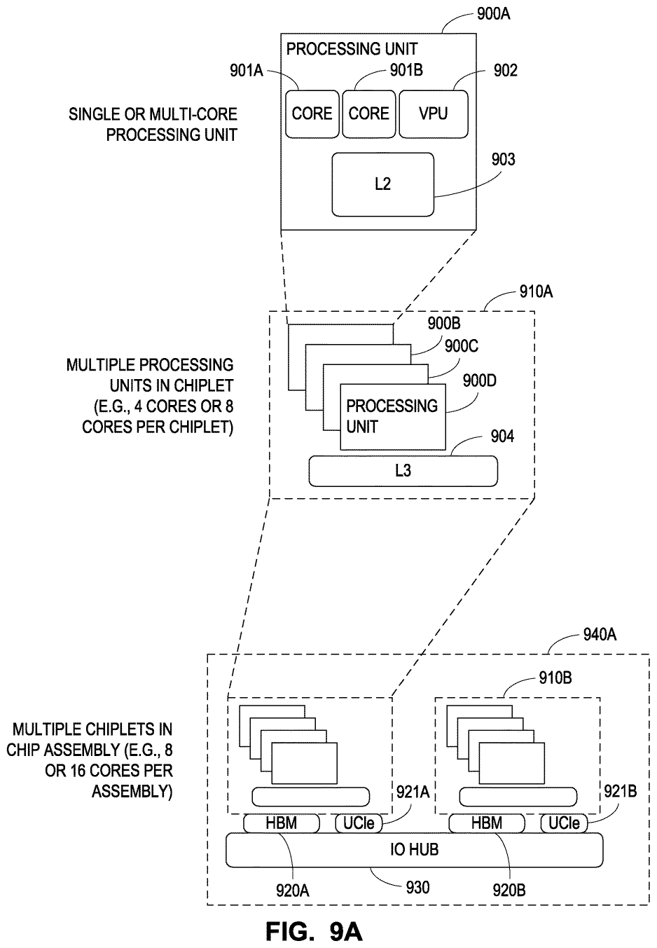

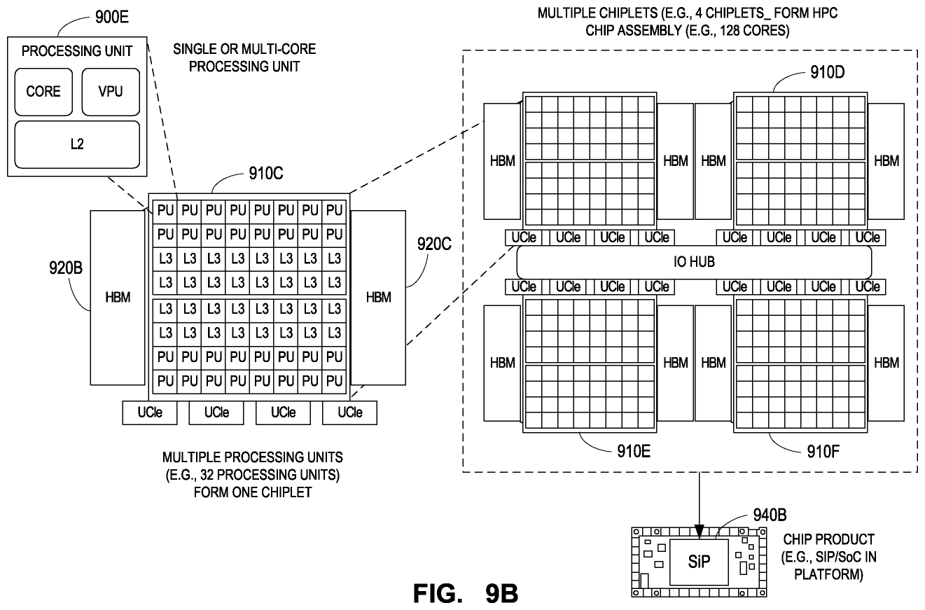

As used herein, a chiplet refers to any integrated circuit (IC) that has a modular structure designed to have one or more specified functionalities and to be combinable with one or more other chiplets on an interposer or other substrate in a package. Examples of chiplets are compute chiplets that include programmable circuitry (e.g., one or more processor circuits, such as one or more cores, etc.) and supporting circuitry (e.g., local memory, etc.) to provide computational functionality (e.g., to execute a host OS, applications, etc.), memory chiplets that include memory accessible to one or more other chiplets, communication chiplets that include communication interfaces (e.g., input/output (I/O) hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers. Example implementations of chiplets are further described below in conjunction with FIGS. 8, 9A, and 9B.

As used herein, a tile refers to any IC that has a modular structure designed to have one or more specified functionalities and to be combinable with other tiles in a chiplet. For example, tiles can group one or more functional circuits into a single tile to implement a specified feature and/or group of features. Furthermore, tiles from different manufacturers can be combined into a given chiplet, and/or tiles can be replicated for inclusion in a given chiplet. Examples of tiles are compute tiles that include one or more processor circuits (e.g., cores) and supporting circuitry (e.g., local memory) to provide processor functionality (e.g., to execute a host OS, applications, etc.) in a chiplet, memory tiles that include memory accessible to one or more other tiles in the chiplet, memory controller tiles to control access to the memory tiles in the chiplets, etc.

As described above, the compute device 102 of FIG. 1 implements a multi-tier management architecture for security enforcement through physical memory regions. Example multi-tier management architectures that include example management tiles and/or example management chiplets disclosed herein may leverage different forms and/or levels of trust. Such different forms and/or levels of trust are also referred to herein as security levels. Such security levels can be utilized individually or in different combinations to achieve one or more overall goals associated with security and/or trust in the management of and/or operation of a compute device such as a tile and/or a chiplet.

For example, management tiles and/or management chiplets disclosed herein may implement one or more security levels related to device security (e.g., also referred to as device security levels) to verify the authenticity and/or integrity of one or more management tiles, one or more management chiplets and/or one or more other tiles and/or chiplets included in the compute device. Additionally or alternatively, example management tiles and/or management chiplets disclosed herein may implement one or more security levels related to client security (e.g., also referred to as client security levels) to verify the authenticity and/or integrity of one or more client devices, one or more of applications, etc., that request access to one or more of tiles and/or one or more of chiplets of the compute device. Additionally or alternatively, example management tiles and/or management chiplets disclosed herein may implement one or more security levels related to privilege verification (e.g., also referred to as privilege levels) to verify that a tile, chiplet, client, code, etc., has appropriate authorization to be granted access to data, one or more features, one or more capabilities, one or more application programing interfaces (APIs), etc., provided by the tiles and/or chiplets of the compute device (e.g., corresponding to available data and/or an approved set of features, capabilities, APIs). Additionally or alternatively, example management tiles and/or management chiplets disclosed herein may implement one or more security levels related to data protection (e.g., also referred to as protection level) to verify that code, one or more features, one or more capabilities, one or more APIs, etc. provided by the tiles and/or chiplets of the compute device have sufficient privilege levels to access code, one or more features, one or more capabilities, one or more APIs, etc. Additionally or alternatively, example management tiles and/or management chiplets disclosed herein may implement one or more security levels related to capability verification (e.g., also referred to as capability levels) to verify that one or more features, one or more capabilities, one or more APIs, etc., provided by the tiles and/or chiplets of the compute device meet one or more expected advertised features, one or more capabilities, one or more APIs, etc., for those tiles and/or chiplets.

In some examples, the security levels associated with example management tiles and/or management chiplets disclosed herein are output as values, such as one or more numeric values, one or more text values, etc., that can be evaluated through one or more operations (e.g., comparisons, concatenations, summations, differences, etc.). For example, two or more different security levels can be combined to develop an overall security value or score for data or an entity such as code, a compute device, programmable circuitry, a tile, and/or a chiplet. In some examples, the values of individual security levels and/or different combinations of security levels can be used to develop several composite security value(s) or score(s) (e.g., at different hierarchical levels) for the data, the code, the compute device, the programmable circuitry, the tile, and/or the chiplet.

Given the different forms of security levels provided by example tiles and/or chiplets disclosed herein, one or more of such security levels may also be referred to using other terminology. For example, security levels may also refer to competence level(s) and/or compliance levels(s) that quantify the suitability of code, data, features, capabilities, APIs, etc., provided by the tiles and/or chiplets for a given task or set of tasks (e.g., such as the competence and/or compliance of an AI/ML model obtained by and/or executed by a given tile and/or chiplet). In some examples, one or more security levels may be referred to as integrity level(s), assurance level(s), validation/validity level(s), privacy level(s), reliability level(s), credibility level(s), safety level(s), explainability level(s), trustworthiness level(s), etc.

In the illustrated example of FIG. 1, the physical memory 106 is implemented in accordance with any type of memory interface standard, such as a Joint Electron Device Engineering Council (JEDEC) standard. Example JEDEC standards include double data rate (DDR) standards such as DDR, DDR2, DDR3, DDR4, DDR5, and DDR6. Additional or alternative DDR standards include mobile DDR (MDDR) standards such as low power DDR (LPDDR), LPDDR2, LPDDR3, LPDDR4, LPDDR5, LPDDR6, etc. DDR standards also include graphics DDR (GDDR) standards such as GDDR, GDDR2, GDDR3, GDDR4, GDDR5, and GDDR6. In some examples, the memory interface standard is a RAMBUS® standard such as extreme data rate (XDR) or XDR2. In the example of FIG. 1, the physical memory 106 is implemented by a volatile memory (e.g., a Synchronous Dynamic Random Access Memory (SDRAM), Dynamic Random Access Memory (DRAM), RAMBUS® Dynamic Random Access Memory (RDRAM), etc.) and/or a non-volatile memory (e.g., flash memory).

While in the illustrated example the physical memory 106 is illustrated as a single memory, the physical memory 106 may be implemented by multiple memories. For example, the physical memory 106 may be a memory chiplet that includes one or more memory tiles. In such an example, the physical memory 106 is a bank of memory that includes multiple memory tiles that can support a multi-channel interface between the physical memory 106 and the compute chiplets 104A-B. In additional or alternative examples, the physical memory 106 may be implemented by any number and/or type(s) of memories. Furthermore, the data stored in the physical memory 106 may be in any data format such as binary data. In the example of FIG. 1, the physical memory 106 is implemented internal to the compute device 102 (e.g., as one or more chiplets and/or one or more tiles). In some examples, the physical memory 106 is implemented externally to the compute device 102. The physical memory 106 of FIG. 1 may be implemented in accordance with a memory form factor such as the dual in-line memory module (DIMM) form factor. Other memory form factors are possible such as the universal DIMM (UniDIMM) form factor, the Accelerated Graphics Port (AGP) in-line memory module (AIMM) form factor, the compression attached memory module (CAMM) form factor, the single in-line memory module (SIMM) form factor, and/or the single in-line pin package (SIPP) form factor.

In the illustrated example of FIG. 1, the management chiplet 108 is not discoverable and, thus, is not accessible by a bare metal OS of the compute device 102 (also referred to herein as the host OS of the compute device 102). In other words, the management chiplet 108 is isolated from the bare metal OS (or host OS) of the compute device 102. As used herein, a bare metal OS refers to an OS that has access to the physical resources of the compute device. In some examples, the bare metal OS corresponds to a host OS that executes on the compute device to provide applications with access to the physical resources of the compute device. In some examples, the bare metal OS is a physical OS that executes below a virtual OS on the compute device and that provides the virtual OS with access to the physical resources of the compute device.

In some examples, isolation of the management chiplet 108 from the bare metal OS of the compute device 102 is also achieved through the use of distinct memory address spaces. For example, the management chiplet 108 may include its own memory and processor circuitry that is distinct from the memories and processor circuitry of the other chiplets, such as the chiplets 104A-B, in the compute device 102. Furthermore, the memory of the management chiplet 108 may be associated with an address space that is distinct from the address spaces of the memories of the other chiplets, such as the chiplets 104A-B, in the compute device 102. Through this distinct address space, the management chiplet 108 can be isolated from access by the bare metal OS (or host OS) executing on the compute tiles 112A-B of the compute chiplets 104A-B.

Likewise, the management tiles 110A-B are not discoverable and, thus, are not accessible by the bare metal OS (or host OS) of the compute device 102. In other words, the management tiles 110A-B are isolated from the bare metal OS (or host OS) of the compute device 102. In some examples, such isolation is achieved through the use of distinct memory address spaces. For example, the compute chiplets 104A-B may include respective compute tiles, such as the respective sets of compute tiles 112A-B, which include respective memories and processor circuitry to execute the bare metal OS (or host OS) of the compute device 102.

In some such examples, a management tile, such as the management tile 110A, may include its own memory and processor circuitry that is distinct from the memories and processor circuitry of those compute tiles. Furthermore, the memory of the management tile 110A may be associated with an address space that is distinct from the address spaces of the memories in the compute tiles 112A-B of the respective compute chiplets 104A-B. Through this distinct address space, the management tile 110A can be isolated from access by the bare metal OS (or host OS) executing on the compute tiles 112A-B of the compute chiplets 104A-B.

In the illustrated example of FIG. 1, the management chiplet 108 and/or the management tiles 110A-B may be instantiated (e.g., create an instance of, bring into being for any length of time, materialize, implement, etc.) by programmable circuitry. For example, the programmable circuitry may be implemented by a CPU executing first instructions, a field programmable gate array (FPGA), a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc. Additionally or alternatively, the management chiplet 108 and/or the management tiles 110A-B of FIG. 1 may be instantiated (e.g., create an instance of, bring into being for any length of time, materialize, implement, etc.) by (i) an ASIC and/or (ii) an FPGA (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the illustrated example of FIG. 1, the management chiplet 108 includes example at least one hardware application programming interface (API) 116, example verification circuitry 118, and example physical memory management (PMM) circuitry 120. In the example of FIG. 1, one or more of the verification circuitry 118 or the PMM circuitry 120 is implemented as a tile including programmable circuitry. For example, one or more of the verification circuitry 118 or the PMM circuitry 120 is implemented by a tile including an FPGA. In some examples, one or more of the verification circuitry 118 or the PMM circuitry 120 is implemented by a tile including an ASIC. In other examples, one or more of the verification circuitry 118 or the PMM circuitry 120 is implemented by a tile including hardware circuitry (e.g., analog circuitry, digital circuitry, etc.). Additionally or alternatively, one or more of the verification circuitry 118 or the PMM circuitry 120 is implemented by a tile including any type of programmable circuitry as described herein. In some examples, the management chiplet 108 and/or components thereof (e.g., the at least one hardware API 116, the verification circuitry 118, and the PMM circuitry 120) are implemented at an I/O hub such as the I/O hub chiplet 841. For example, the I/O hub includes the functionality of the management chiplet 108 in such examples. In examples disclosed herein, an I/O hub refers to a chiplet that connects two or more chiplets on a device and routes communications between the two or more chiplets. For example, an I/O hub is implemented by an interposer including connections to two or more chiplets and routing logic to route communications between the two or more chiplets. Example I/O hubs also manage and orchestrate routing rules of the I/O hub.

In the illustrated example of FIG. 1, the verification circuitry 118 and the PMM circuitry 120 are implemented as part of the management chiplet 108. As such, other entities (e.g., the compute chiplets 104A-B) cannot access the verification circuitry 118 and the PMM circuitry 120 except through the at least one hardware API 116 as described herein. In some examples, applications developed based on the at least one hardware API 116 can be implemented in a secure enclave (e.g., a separate coprocessor, a VM, a container, etc.) provided by additional or alternative hardware APIs such as a Software Guard Extensions (SGX) enclave provided by Intel Corporation® or a Trust Domain Extensions (TDX) enclave provided by Intel Corporation®. Additionally or alternatively, the secure enclave may be implemented by a MultiZone™ Security enclave provided by Hex Five Security, a Keystone Customizable TEE, or a scalable TEE for a RISC-V architecture compute device such as a scalable TEE developed by Penglai. In some examples, the secure enclave is implemented by a Platform Security Processor (PSP) provided by Advanced Micro Devices (AMD), Inc. or a Secure Encrypted Virtualization (SEV) enclave provided by AMD, Inc. In some examples, the secure enclave is implemented by a TrustZone® provided by Advanced RISC Machine (ARM) Holdings public limited company (PLC).

In the illustrated example of FIG. 1, the management chiplet 108 enforces security on the compute device 102. For example, the compute device 102 implements a trust model enforced by the management chiplet 108. In examples disclosed herein, the trust model assumes that hardware can be trusted, that software running on the management chiplet 108 can be trusted at all privilege levels, and that software running on the compute chiplets 104A-B cannot be trusted at any privilege level, including firmware and/or basic input output system (BIOS) instructions. In some examples, the management chiplet 108 is referred to as a data management unit (DMU). A DMU may include hardware and/or software to manage interoperability between devices (e.g., between one or more chiplets, one or more processors, and/or one or more network devices). A DMU may handle communication (including authentication) between heterogeneous devices, including with the use of packet-based communication models, thereby enabling high speed connection between devices that may operate in accordance with the same or different protocols. A DMU, in some examples, may also operate in the role of a Network on a Chip (NoC) communication subsystem within an integrated circuit package, such as in an on-chip or on-package network established from an interposer.

In some examples, a DMU may perform attestation and/or validation. For example, a DMU may attest and/or validate hardware, software, firmware, and/or data connected to, instantiated on, executed on, and/or loaded on a host device. In some examples, a DMU may quarantine hardware, software, firmware, and/or data that failed attestation and/or that was attested at a level lower than verified (also referred to as trusted).

A DMU may perform workload orchestration among heterogeneous devices thereby enabling efficient system operation (e.g., in terms of computational efficiency, memory efficiency, and/or power efficiency). A DMU may be implemented as a discrete integrated circuit (e.g., may be a chiplet) separate from the devices it manages, or may be distributed across multiple devices (e.g., may be instantiated in part in several different integrated circuits (e.g., chiplets) included in a semiconductor package). A DMU may allow mixing and matching of chiplets and/or other integrated circuits (e.g., CPU or GPU processors, memory, or other IP blocks) with different functions from the same or different vendors.

The DMU chiplet 108 handles infrastructure processing. In some examples, this infrastructure processing accelerates and/or offloads infrastructure workloads from the main CPU, or chiplet, thereby enhancing efficiency, performance, and/or security for cloud and/or enterprise environments. By handling tasks such as networking, storage virtualization, and/or data processing in dedicated, programmable hardware, the DMU chiplet 108 frees up host CPUs and/or chiplets for customer applications, reduces (e.g., minimizes) latency, and provides better resource utilization and control.

In the illustrated example of FIG. 1, the management chiplet 108 manages the physical memory 106 to enforce security on the compute device 102. For example, the compute chiplets 104A-B utilizes an example virtual memory space 122 that may be mapped to the physical memory 106 via the logical page tables 114A-B. That is, the physical memory 106 includes multiple regions that may be mapped to corresponding regions in the virtual memory space 122. In the example of FIG. 1, the physical memory 106 includes an example first physical memory region 124, an example second physical memory region 126, an example third physical memory region 128, and an example fourth physical memory region 130.

In the illustrated example of FIG. 1, the first physical memory region 124, the second physical memory region 126, the third physical memory region 128, and the fourth physical memory region 130 are continuous, non-overlapping physical memory ranges that are identified by respective start addresses and sizes (or respective end addresses). The start and/or end addresses of the first physical memory region 124, the second physical memory region 126, the third physical memory region 128, and the fourth physical memory region 130 are defined in physical memory addresses. In the example of FIG. 1, each region of the physical memory 106 is associated with a security level enforced by the management chiplet 108. For example, the security level of a physical memory region is identified by metadata stored in the PMM circuitry 120.

In the illustrated example of FIG. 1, when the compute chiplets 104A-B and/or an example data provider 132 stores code in the physical memory 106, the security level of the region of the physical memory 106 in which the code is stored is initially unprivileged. In the example of FIG. 1, the first physical memory region 124 stores unprivileged code. Also, when the compute chiplets 104A-B and/or the data provider 132 stores data in the physical memory 106, the security level of the region of the physical memory 106 in which the data is stored may be initially unprotected or protected. For example, if the compute chiplets 104A-B and/or the data provider 132 do/does not request protection (e.g., via the at least one hardware API 116), the security level of the region of the physical memory 106 in which the data is stored will be initially unprotected. In the example of FIG. 1, the second physical memory region 126 stores unprotected data.

In the illustrated example of FIG. 1, if code is to be privileged and/or data is to be protected, the compute chiplets 104A-B and/or the data provider 132 transmits a security level adjustment request to the management chiplet 108 via the at least one hardware API 116 to adjust a security level of one or more regions of the physical memory 106. For code that is to be privileged, the management chiplet 108 can assign a privilege level (e.g., privileged code including varying levels of privilege) to the code. For example, after verification of code by the verification circuitry 118, the PMM circuitry 120 can assign a privilege level to the code and store the privilege level in metadata for a region of the physical memory 106 in which the code is stored. In the example of FIG. 1, the third physical memory region 128 stores privileged code. As used herein, a privilege level refers to a degree of control that a process or code has over a compute system.

As described above, when the compute chiplets 104A-B and/or the data provider 132 stores data in the physical memory 106, the region of the physical memory 106 in which the code is stored may be initially unprotected or protected. For data that is to be protected, the compute chiplets 104A-B and/or the data provider 132 can request protection before providing the data for storage in the physical memory 106. In the example of FIG. 1, for data that is to be protected, the management chiplet 108 can assign a protection level (e.g., unprotected, restricted, protected) to the data. For example, after verification of data and/or a data provider (e.g., the data provider 132) by the verification circuitry 118, the PMM circuitry 120 can assign a protection level to the data and store the protection level in metadata for a region of the physical memory 106 in which the data is to be stored. In the example of FIG. 1, the fourth physical memory region 130 stores protected data. As used herein, a protection level refers to a degree of security, privacy, and control applied to data depending on, for example, the sensitivity, regulatory requirements, and/or risk of exposure of the data.

In some examples, the physical memory 106 includes additional or alternative regions that are not non-overlapping like the first physical memory region 124, the second physical memory region 126, the third physical memory region 128, and the fourth physical memory region 130. In such examples, the contents of the additional or alternative physical memory regions are associated with the lowest security level. For example, if a potentially overlapping memory region stores code, the management chiplet 108 assigns the lowest privilege level (e.g., unprivileged) to the physical memory region by default. As such, the code stored in the potentially overlapping memory region is prevented from accessing any protected memory regions having any protection level above unprotected.

If a potentially overlapping memory region stores data, the management chiplet 108 assigns the lowest protection level (e.g., unprotected) to the physical memory region by default. As such, any code is permitted access the data regardless of privilege level of the code. Accordingly, if sensitive data provided by the compute chiplets 104A-B and/or the data provider 132 is to be secured, the compute chiplets 104A-B and/or the data provider 132 is/are “forced” to request an elevated protection level for the data to prevent unauthorized access to the data. Thus, the trust model enforced by the management chiplet 108 ensures that security is enforced for sensitive data.

In the illustrated example of FIG. 1, the management chiplet 108 can assign an integrity level (e.g., verified, unverified, etc.) to code or data depending on whether the code or data has been attested by, for example, the verification circuitry 118. As used herein, an integrity level refers to a degree of trust in, for example, code, data, and/or a data provider. As described above, the compute chiplets 104A-B and/or the data provider 132 can request adjustment of a security level of one or more regions of the physical memory 106. For example, the compute chiplets 104A-B and/or the data provider 132 request adjustment of a security (e.g., privilege, protection, and/or integrity) level via the at least one hardware API 116. In this manner, the compute chiplets 104A-B and/or the data provider 132 can define and update metadata for physical memory regions of the physical memory 106 (after verification by the verification circuitry 118).

In the illustrated example of FIG. 1, the at least one hardware API 116 can be implemented in multiple manners. For example, the at least one hardware API 116 is implemented as at least one dedicated and/or predefined set of registers mapped to physical memory ranges through which the compute chiplets 104A-B and/or the data provider 132 can register privileged code and/or protected data with the management chiplet 108. Based on the at least one set of registers of the management chiplet 108, the compute chiplets 104A-B and/or the data provider 132 can register privileged code and/or protected data with the management chiplet 108.

In the illustrated example of FIG. 1, the at least one hardware API 116 is illustrated as at least one interface of the management chiplet 108. In some examples, the at least one hardware API 116 is implemented as at least one interface of the PMM circuitry 120. In such examples, the at least one set of registers described above is the at least one set of registers of the PMM circuitry 120. In some examples, the at least one hardware API 116 is implemented by a single multi-function API. Additionally or alternatively, the at least one hardware API 116 is implemented by multiple APIs where each of the APIs has relatively less functionality compared to a single multi-function API.

In an example where the at least one hardware API 116 is implemented by multiple APIs, a first API (e.g., a first set of registers) allows the compute chiplets 104A-B and/or the data provider 132 (e.g., a sensor) to allocate a protected region in the physical memory 106 where data output by the compute chiplets 104A-B and/or the data provider 132 can be stored (after validation by the verification circuitry 118 based on metadata provided by the compute chiplets 104A-B and/or the data provider 132). As such, the compute chiplets 104A-B and/or the data provider 132 can upgrade the protection level of a physical memory region. Additionally, in an example where the at least one hardware API 116 is implemented by multiple APIs, a second API (e.g., a second set of registers) can be accessed by the compute chiplets 104A-B and/or the data provider 132 to upgrade an unprivileged memory region to privileged (after an integrity check (e.g., attestation) by the verification circuitry 118).

In an example where the at least one hardware API 116 is implemented by multiple APIs, a third API (e.g., a third set of registers) can be accessed by the compute chiplets 104A-B and/or the data provider 132 to relinquish a protected or privileged region to restore the physical memory region to a default security level (e.g., the lowest security level). For example, after sensitive data is removed from a protected physical memory region or the protected physical memory region is flushed (e.g., data is deleted, overwritten, etc.), the compute chiplets 104A-B and/or the data provider 132 can request, via the at least one hardware API 116, that the protection level of the physical memory region be downgraded. Likewise, if privileged code is to be downgraded to unprivileged, the compute chiplets 104A-B and/or the data provider 132 can request, via the at least one hardware API 116, that the privilege level of the physical memory region be downgraded. In some examples, the PMM circuitry 120 can downgrade the security level of a physical memory region without a request from the compute chiplets 104A-B and/or the data provider 132. For example, after a certain time period an elevated privilege level for code can expire and the PMM circuitry 120 can downgrade the privilege level of the code.

As described above, the compute chiplets 104A-B and/or the data provider 132 can request storage of code and/or data in a region of the physical memory 106. In the example of FIG. 1, one or more of the compute chiplets 104A-B executes an application from which code can be launched. For example, one or more of the compute chiplets 104A-B executes an AI/machine learning (ML) framework application such as Tensorflow, Pytorch, or Keras from which one or more AI/ML models can be launched. Additionally or alternatively, the data provider 132 can provide data to the compute device 102 for storage in the physical memory 106.

In the illustrated example of FIG. 1, the data provider 132 is an entity that generates data to be stored by the physical memory 106 and/or analyzed by the compute chiplets 104A-B. For example, data provided by the data provider 132 may be sensitive such as biometric data (e.g., fingerprints, facial scans, iris scans, voice signatures, hand geometry, palm prints, deoxyribonucleic acid (DNA) sequences, typing rhythms, gait analyses, images including faces, etc.) and personal information (e.g., names, addresses, social security numbers, etc.). Other examples of sensitive data include health records, financial information, data related to political opinions, data related to religious beliefs, data related to sexual orientation, intellectual property, and trade secrets, among others.

In the illustrated example of FIG. 1, the data provider 132 is a sensor such as a camera. In some examples, the data provider 132 can be implemented by any other type of sensor such as a pressure sensor (e.g., a blood pressure sensor), a biochemical sensor (e.g., a glucose monitor, a pulse oximeter, a pregnancy test, etc.), an image sensor (e.g., an X-ray machine, an ultrasound machine, a magnetic resonance imaging (MRI) machine, a positron emission tomography (PET) scanner, etc.), a temperature sensor (e.g., a thermometer), and a respiration rate sensor, among others. In additional or alternative examples, the data provider 132 is implemented by an accelerometer, a light sensor, a sound sensor, a pressure sensor, a camera, a thermal sensor, an electrical field sensor, a chemical sensor, an infrared sensor, or a seismic sensor, among others. In some examples, the data provider 132 is an entity internal to the compute device 102. In such examples, the data provider 132 may be a chiplet of the compute device 102.

As described above, the data provider 132 generates sensitive data to be stored by the physical memory 106 and can request allocation of a protected region in the physical memory 106 where the sensitive data is to be stored (after validation by the verification circuitry 118 based on metadata provided by the data provider 132). In the example of FIG. 1, the system 100 also includes example direct memory access (DMA) circuitry 134 and example I/O memory management (IOMM) circuitry 136. For example, the DMA circuitry 134 permits the data provider 132 to store sensitive data directly in a protected region of the physical memory 106 such as the fourth physical memory region 130. In the example of FIG. 1, the IOMM circuitry 136 includes a copy of the security level metadata stored in the PMM circuitry 120 and enforces the security level metadata for the fourth physical memory region 130.

In the illustrated example of FIG. 1, one or more of the DMA circuitry 134 or the IOMM circuitry 136 is implemented by a compute device such as an SoC, an ASIC, a semiconductor device, a chip, etc., or another type of compute device. Additionally or alternatively, one or more of the DMA circuitry 134 or the IOMM circuitry 136 is implemented by a chiplet including programmable circuitry. For example, one or more of the DMA circuitry 134 or the IOMM circuitry 136 is implemented by a chiplet including an FPGA. In some examples, one or more of the DMA circuitry 134 or the IOMM circuitry 136 is implemented by a chiplet including an ASIC. In other examples, one or more of the DMA circuitry 134 or the IOMM circuitry 136 is implemented by a chiplet including hardware circuitry (e.g., analog circuitry, digital circuitry, etc.). Additionally or alternatively, one or more of the DMA circuitry 134 or the IOMM circuitry 136 is implemented by a chiplet including any type of programmable circuitry as described herein. In some examples, the verification circuitry 118 includes a secure enclave to aid in performance of attestation.

As described above, the management chiplet 108 can assign an integrity level (e.g., verified, unverified, etc.) to code or data depending on whether the code or data has been attested. In the example of FIG. 1, based on a request from the compute chiplets 104A-B and/or the data provider 132 to increase a security level (e.g., a privilege level and/or a protection level) of a region of the physical memory 106 storing code and/or data, the verification circuitry 118 can verify whether the code and/or the data is legitimate before the PMM circuitry 120 adjusts the security level of the region of the physical memory 106. For example, the verification circuitry 118 can verify whether a certificate or signature associated with the code or data is a legitimate certificate or signature provided by a reputable entity such as a certificate authority. Additionally or alternatively, the verification circuitry 118 can communicate with an external attestation service (e.g., IAS, Microsoft Azure Attestation, AWS Nitro Attestation, Google Confidential Computing Attestation, TPM Remote Attestation, etc.) hosted by a server (e.g., an attestation server) to verify whether code or data is legitimate.

In some examples, the verification circuitry 118 performs attestation of the compute chiplets 104A-B and/or the data provider 132 to securely receive and/or store code (e.g., AI/ML models) and/or data (e.g., training datasets). For example, the verification circuitry 118 attests the identity of a code and/or data provider (e.g., the compute chiplets 104A-B and/or the data provider 132) by receiving proof-of-identity (e.g., a certificate, a signature, etc.) from the code and/or data provider. In some examples, the verification circuitry 118 attests the identity of the code and/or data provider using a trusted server such as an external attestation service.

In the illustrated example of FIG. 1, after the verification circuitry 118 verifies code, data, and/or a code and/or data provider as legitimate, the verification circuitry 118 indicates to the PMM circuitry 120 that the code, data, and/or the code and/or data provider has been attested. For example, the verification circuitry 118 communicates a notification to the PMM circuitry 120 where the notification indicates that the code, data, and/or the code and/or data provider has been attested. The PMM circuitry 120 receives the notification and determines whether the code, the data, and/or the code and/or data provider has been attested as legitimate. Provided that the verification circuitry 118 confirms that the code, data, and/or the code and/or data provider is legitimate, the PMM circuitry 120 adjusts the security level of a region of the physical memory 106 in which the code and/or data is or is to be stored and identifies an integrity level of the code and/or data in metadata associated with the region. In some examples, after the verification circuitry 118 confirms that a code and/or the data provider is legitimate, the PMM circuitry 120 discovers the type(s) of code, data, and/or variables that can be accessed via the code and/or data provider. In such examples, the PMM circuitry 120 registers with the code and/or data provider to receive code, data, and/or variables of interest.

As described above, the PMM circuitry 120 adjusts the security level of a region of the physical memory 106 in which code and/or data is or is to be stored after verification of the code, the data, and/or a code and/or data provider as legitimate. In the example of FIG. 1, the PMM circuitry 120 discovers the types of code, data, and/or variables that can be accessed via attested code. Based on the sensitivity of code, data, and/or variables, the PMM circuitry 120 adjusts the security level of the attested code. For example, if the attested code can access privileged code, protected data, and/or variables included in protected data and/or privileged code, the PMM circuitry 120 adjusts the privilege level of the code to the requisite level corresponding to the security level of the privileged code and/or the security level needed to access the protected data and/or the variables.

In some examples, the PMM circuitry 120 accesses sensitivity information included in metadata of attested code. For example, the sensitivity information specifies what type (e.g., the protection level) of data the code is to access and what type (e.g., the protection level) of data the code is to generate. Based on the sensitivity information, the PMM circuitry 120 adjusts the privilege level of the code to the requisite level needed to access the type of data that the code is to access. Additionally, if the code is to generate sensitive data, the PMM circuitry 120 can establish a protected physical memory region in which the data is to be stored.

In the illustrated example of FIG. 1, the PMM circuitry 120 discovers the types of code, data, and/or variables that are accessible via attested data. Based on the sensitivity of code, data, and/or variables, the PMM circuitry 120 adjusts the security level of the attested data. For example, if the attested data includes privileged code, protected data, and/or variables included in protected data and/or privileged code, the PMM circuitry 120 adjusts the protection level of the data to the requisite level corresponding to the security level of the privileged code and/or the security level needed to access the protected data and/or the variables.

In some examples, the PMM circuitry 120 accesses sensitivity information included in metadata provided by an attested data provider. For example, the sensitivity information specifies what type (e.g., the protection level) of data the data provider is to provide. That is, the sensitivity information specifies whether the data to be provided by the data provider includes personally identifiable information or other sensitive information as described herein. Based on the sensitivity of the data to be provided by the data provider, the PMM circuitry 120 adjusts the protection level of the data to a level that complies with a standard, data governance policy, law, and/or regulation with which an enterprise managing the data is to comply.

In the illustrated example of FIG. 1, the verification circuitry 118 supervises and/or performs a handshake between the compute device 102 and a code and/or data provider (e.g., allowing the compute device 102 and the code and/or data provider to establish a secure connection by authenticating the parties involved). For example, the code and/or data provider and the compute device 102 handshake using a symmetric key (e.g., a single key used to encrypt and decrypt data during a given session, ensuring both parties can securely exchange information with high speed and efficiency). As such, the symmetric key allows the compute device 102 to send and store code and/or data securely. In some examples, establishing a connection between the compute device 102 and the code and/or data provider can involve the use of asymmetric encryption for initial key exchange, while the actual data encryption during the session is performed using a symmetric key (e.g., allowing for faster data processing speeds).

In some examples, the verification circuitry 118 performs attestation of the code and/or data provider using a first encryption key (e.g., an asymmetric key), such that the attestation is based on a validation of the code and/or data provider using a server (e.g., a trusted server). In some examples, the compute device 102 receives code (e.g., an AI/ML model) and/or data (e.g., training data) from a code and/or data provider using a second encryption key (e.g., a symmetric key), where the first encryption key and the second encryption key are generated by a chiplet. In examples disclosed herein, the verification circuitry 118 can be on an edge system located in proximity to a code and/or data provider (e.g., electronic proximity based on communication latency, geographic proximity, etc.). However, the location of the verification circuitry 118 disclosed herein is not limited and can also be based on a data server located far from a code and/or data provider. While symmetric and asymmetric keys are used in the examples disclosed herein, any other type of encryption can be used (e.g., quantum encryption, etc.), since the verification circuitry 118 can work with any type of secure channel.

In some examples, one or more of the compute chiplets 104A-B store code in a region of the physical memory 106 and execute the code without verification or attestation by the verification circuitry 118. For example, the compute chiplet 104A stores an AI/ML model in a region of the physical memory 106 and executes the AI model to perform debugging and inspection, operations that are often disabled when code is executed in an enclave or other secure environments. In examples disclosed herein, when code is unverified or unattested, the PMM circuitry 120, or, more generally, the management chiplet 108 assigns the lowest privilege level (e.g., unprivileged) to the physical memory region storing the code. Thus, in examples where an AI model executes without verification or attestation, the AI model is unprivileged and can only access unprotected data (e.g., dummy data, public samples, etc.). As such, the AI model can be debugged or inspected without the risk of compromising sensitive data or code.

In the illustrated example of FIG. 1, after code and/or data stored in the physical memory 106 have/has been designated as privileged and/or protected, respectively, the PMM circuitry 120, and/or, more generally, the management chiplet 108 enforces a permission model for access requests to the physical memory 106. For example, the permission model includes an operation type O (e.g., O=[Load or Read, Store or Write]), a data protection type L (e.g., lock type, level of encryption, etc.), a code privilege type K (e.g., key type, encryption key, etc.), and a memory access operation access (o: O, k: K, l: L): bool that returns true if and only if code with privilege k can perform operation o and access data with protection l. As such, respective protection levels assigned to data are elements of the set L and respective privilege levels assigned to code are elements of the set K. During operation, the PMM circuitry 120, and/or, more generally, the management chiplet 108 performs runtimes checks to ensure that the permission model is enforced.

For example, the PMM circuitry 120 validates memory access operations based on (1) the attempted operation o (e.g., Load or Store), (2) the privilege level k of the current instruction attempting to perform the operation (e.g., as identified in the memory page of the virtual memory space 122 including the Program Counter and mirrored from the corresponding range in the physical memory 106), and (3) the protection level l of data stored in the accessed memory address (e.g., mirrored to the logical page tables 114A-B from the metadata maintained by the PMM circuitry 120). If access(o, k, l)=false, the PMM circuitry 120 generates a General Protection fault that indicates that the attempted operation is not permitted. In some examples, enforcement of the permission model by the PMM circuitry 120 is implemented in addition to other security techniques such as control flow integrity (CFI) and/or the physical memory protection (PMP) feature provided by the reduced instruction set computer (RISC) V architecture.

In the illustrated example of FIG. 1, the permission model enforced by the PMM circuitry 120 can be implemented in a variety of ways. One example implementation of the permission model distinguishes between protected and unprotected data and privileged and unprivileged code. Another example implementation of the permission model is level-based where both protections and privileges are elements of the same ordered set and access to data with a given protection level requires a privilege level equal to or greater than the protection level. Another example implementation of the permission model is token-based where data is guarded by atomic tokens from a set, and code is given privileges through sets of the tokens. An access to data by a code range is valid if the code has the access token for those data (potentially among others).

In the illustrated example of FIG. 1, regardless of the implementation of the permission model, each memory access operation type (e.g., Load or Store) can be associated with separate protections and privileges. For example, when enforcing the permission model for a load operation, the PMM circuitry 120, and/or, more generally, the management chiplet 108 checks that code requesting to load data having a protection level (or lock) has the appropriate privilege level (or key) to load or read the data. Likewise, when enforcing the permission model for a store operation, the PMM circuitry 120, and/or, more generally, the management chiplet 108 checks that the code requesting to store data in a region of the physical memory 106 including protected data has the appropriate privilege level to store or write the data to the region.

As described above, the compute chiplets 104A-B access the physical memory 106 via the virtual memory space 122 that is mapped to the physical memory 106 via the logical page tables 114A-B. For example, the virtual memory space 122 includes an example first virtual memory region 138 that is mapped to the first physical memory region 124, an example second virtual memory region 140 that is mapped to the second physical memory regions 126, an example third virtual memory region 142 that is mapped to the third physical memory region 128, and an example fourth virtual memory region 144 that is mapped to the fourth physical memory region 130. In the example of FIG. 1, the compute chiplets 104A-B utilize the logical page tables 114A-B, respectively, to convert between the virtual memory space 122 and the physical memory 106.

In some examples, the logical page tables 114A-B also cache security level metadata associated with regions of the physical memory 106 to accelerate security checks. For example, each of the logical page tables 114A-B includes logical pages that cache security level metadata associated the first physical memory region 124, the second physical memory region 126, the third physical memory region 128, and the fourth physical memory region 130. As such, respective memory management units (MMUs) of the compute chiplets 104A-B can reference the cached security level metadata when the compute tile(s) 112A-B request access to the physical memory 106 via the virtual memory space 122. In such examples, logical pages included in the logical page tables 114A-B are contained within a region of the physical memory 106.

In examples disclosed herein, the bounds of the physical memory regions mapped to the logical pages of the logical page tables 114A-B do not overlap. The mapped physical memory regions correspond to bounded code and/or data. In examples where the compute chiplets 104A-B include a cache hierarchy, the compute chiplets 104A-B propagate security level metadata throughout the cache hierarchy. For example, if the cache hierarchy of the compute chiplets 104A-B includes three levels, the compute chiplets 104A-B propagate security level metadata to the level 1 (L1) cache, the level 2 (L2) cache, and the level 3 (L3) cache. In this manner, respective MMUs of the compute chiplets 104A-B can access security level metadata with reduced latency.

In examples where security level metadata is cached at the compute chiplets 104A-B, the security level metadata is updated according to, or backed up by, the security level metadata stored in the PMM circuitry 120. As such, examples disclosed herein enforce the trust and/or the permission models disclosed herein in such examples, even in the event that security of the compute chiplets 104A-B is compromised. For example, to update a page within one of the logical page table 114A, the compute chiplet 104A sends a proposed mapping between a virtual memory range and a physical memory range to the PMM circuitry 120 via the at least one hardware API 116. In such an example, the PMM circuitry 120 checks that the bounds of the proposed mapping are valid and, provided that the proposed mapping is valid, the PMM circuitry 120 populates the logical page table 114A with the associated security level metadata stored in the PMM circuitry 120. Alternatively, if the proposed mapping is not permitted (e.g., the proposed mapping attempted to map a page to a privileged region that has not been attested), the PMM circuitry 120 generates a protection fault.

In examples where security level metadata is cached at the compute chiplets 104A-B, the compute chiplets 104A-B update the logical page tables 114A-B in many situations. For example, if the OS implements page table isolation of the logical pages tables 114A-B to segregate virtual addresses between user and system space, the compute chiplets 104A-B update the logical page tables 114A-B on every system call. Also, for example, the compute chiplets 104A-B update the logical page tables 114A-B on every scheduler context switch (e.g., when the scheduler of the OS stops running one process and starts running another process). In examples disclosed herein, the compute chiplets 104A-B update the logical pages tables 114A-B in a number of other situations including when pages for kernel or user space processes are allocated and/or deallocated.

In examples disclosed herein, prohibited updates to the logical page tables 114A-B include updates to swap a protected physical memory region to external storage (e.g., an attached storage disk). For example, because the OS on the compute chiplets 104A-B does not have the requisite privileges to access protected physical memory regions, the OS cannot swap protected physical memory regions to external storage. Additionally, prohibiting such swaps ensures the integrity of data in protected memory regions is maintained. For example, if protected data is stored on an external storage device or disk, an external actor has the opportunity to alter the protected data. Thus, it is not possible to ensure that protected data is legitimate after the protected data is stored on and restored from an external storage device or disk without revalidating the data as described above (e.g., via the verification circuitry 118). As such, preventing swaps of protected physical memory regions to external storage avoids this complication while ensuring security. In some examples, the PMM circuitry 120 manages and/or updates the logical page tables 114A-B instead of the compute chiplets 104A-B.

As described above, by virtue of security level metadata being cached at the compute chiplets 104A-B based on the PMM circuitry 120 rather than being controlled by supervisory instructions (e.g., firmware, OS, etc.) running of the compute chiplets 104A-B, examples disclosed herein enforce the trust and/or the permission models disclosed herein. For example, as described above, the start and/or end addresses of the physical memory regions are defined in physical memory addresses. As such, any protections and/or privileges on the data and/or code stored in physical memory regions cannot be altered by using different virtual and/or logical addresses in the logical page tables 114A-B. Thus, security level metadata stored in the logical page tables 114A-B is not set by the compute chiplets 104A-B but is populated from the information stored in the PMM circuitry 120.

In some examples, the management tiles 110A-B implement similar capabilities as described above, but with respect to the compute chiplets 104A-B. For example, each of the management tiles 110A-B includes an instance of the at least one hardware API 116, the verification circuitry 118, and the PMM circuitry 120 that enforce the permission model within the compute chiplets 104A-B, respectively. Additionally, the management tiles 110A-B implement the management capabilities (e.g., observing/monitoring capabilities and/or control capabilities, etc.) of their respective compute chiplets 104A-B in the compute device 102.

For example, the management tile 110A may perform power management associated with the compute tile(s) 112A included in the compute chiplet 104A, monitor utilization of one or more cores of the compute tile(s) 112A included in the compute chiplet 104A, monitor temperature of the core(s) of the compute tile(s) 112A included in the compute chiplet 104A, perform clock frequency regulation associated with the compute tile(s) 112A included in the compute chiplet 104A, perform voltage regulation associated with the compute tile(s) 112A included in the compute chiplet 104A, access telemetry associated with the compute tile(s) 112A included in the compute chiplet 104A, etc. In some examples, the management tile 110A implements at least one API to control one or more features of the compute chiplet 104A and/or observe one or more states of the compute chiplet 104A.

In some examples, one or more of the management tiles 110A-B operate independently. For example, the management tile 110A may operate independently and autonomously and use its at least one API to control feature(s) (e.g., characteristic(s), property or properties, circuit element(s), etc.) of a compute tile included in the compute chiplet 104A and/or observe state(s) of a compute tile included in the compute chiplet 104A. However, in some examples, one or more of the management tiles 110A-B operate in combination with the management chiplet 108. For example, the management tile 110A may be coupled to and communicate with the management chiplet 108 and provide (e.g., grant) the management chiplet 108 access to its at least one API to control feature(s) and/or observe state(s) of tiles included in the compute chiplet 104A.

As described herein, in some examples, the management chiplet 108 implements a discovery protocol to discover the management tiles 110A-B. In some such examples, after discovery, the management chiplet 108 obtains respective capability information from the management tiles 110A-B that identifies the at least one API implemented by the respective management tiles 110A-B to control feature(s) and/or observe state(s) of their corresponding compute chiplets 104A-B (e.g., such as the feature(s) and/or state(s) of the tiles included in their corresponding compute chiplets 104A-B). As disclosed herein, in some examples, the management chiplet 108 also authenticates the management tiles 110A-B after the management tiles 110A-B are discovered. In some such examples, the management chiplet 108 stores results of the authentication of the management tiles 110A-B and uses the stored authentication results to skip performing subsequent authentications of the management tiles 110A-B after a reboot of the compute device 102.

As described herein, in some examples, one or more of the management tiles 110A-B may also implement the discovery protocol to authenticate the management chiplet 108 and select at least one API from a set of available APIs based on the authentication of the management chiplet 108. For example, the management tile 110A may evaluate a certificate and/or other access control information provided by the management chiplet 108 to select the at least one API (e.g., a selected, approved subset of APIs that is permitted to be accessed by the management chiplet 108) from a set of available APIs implemented by the management tile 110A. The management tile 110A may then identify the selected one or more APIs (e.g., the approved subset of APIs) in the capability information provided to the management chiplet 108.

In some such examples, the management tile 110A may further restrict the management chiplet 108 from access to other API(s) in the set of available APIs that were not selected based on the authentication of the management chiplet 108 (e.g., corresponding to a restricted set of APIs that is blocked/restricted from access by the management chiplet 108). In some examples, the management tile 110A stores a result of the authentication of the management chiplet 108 in persistent memory and uses the stored authentication result to skip performing a subsequent authentication of the management chiplet 108 after a reboot of the compute device 102.

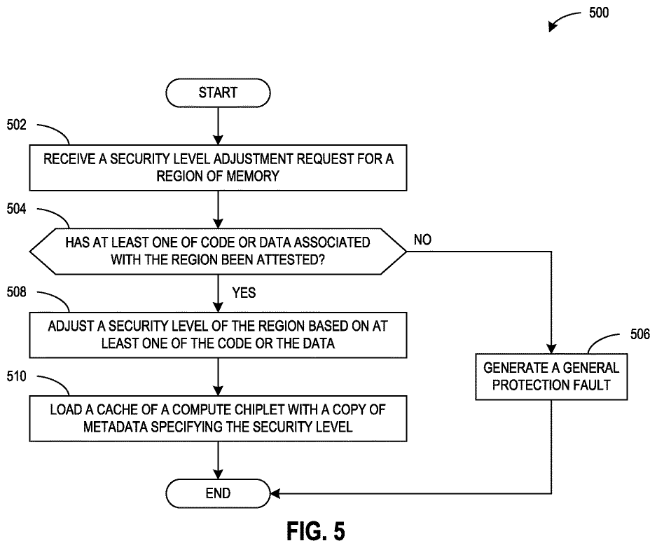

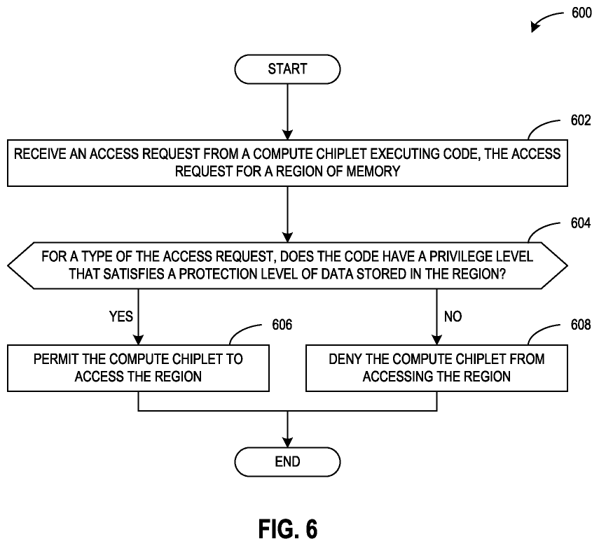

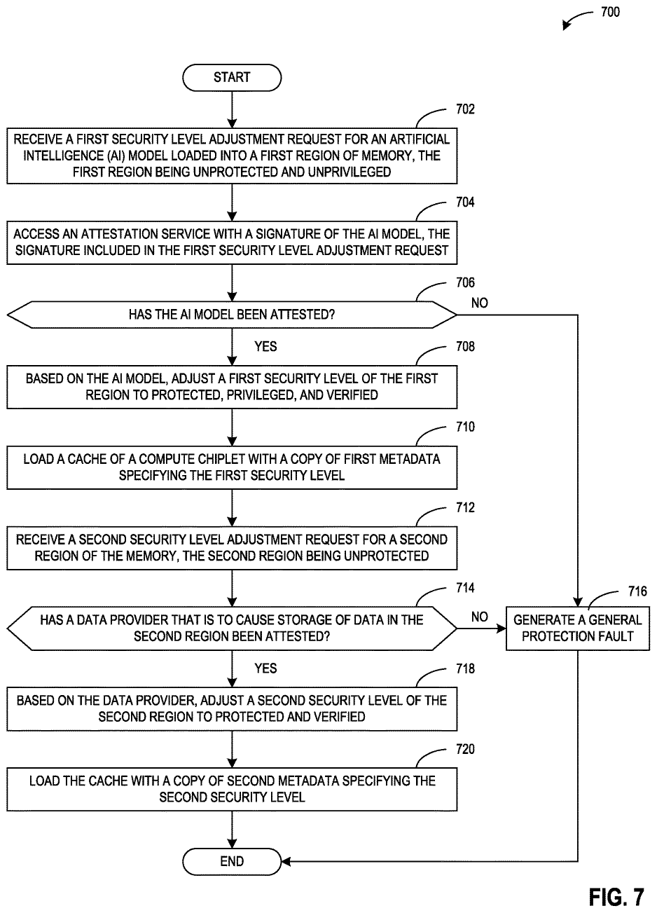

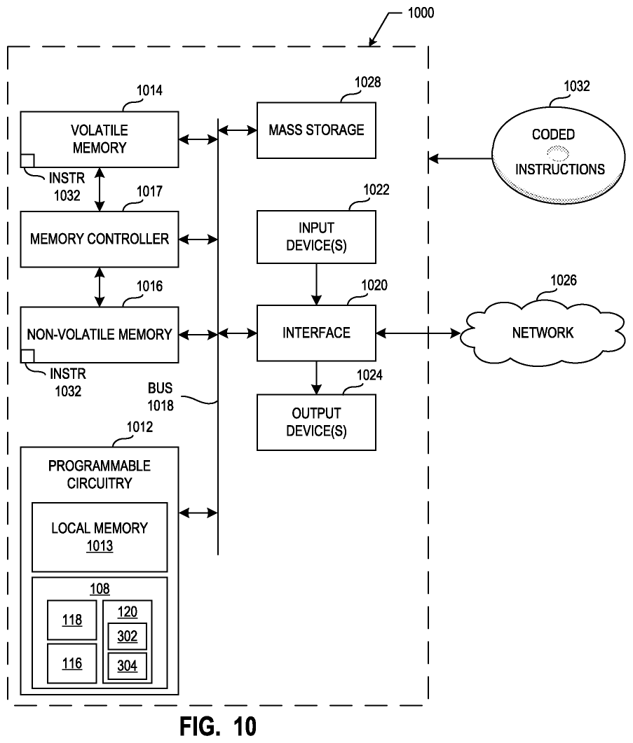

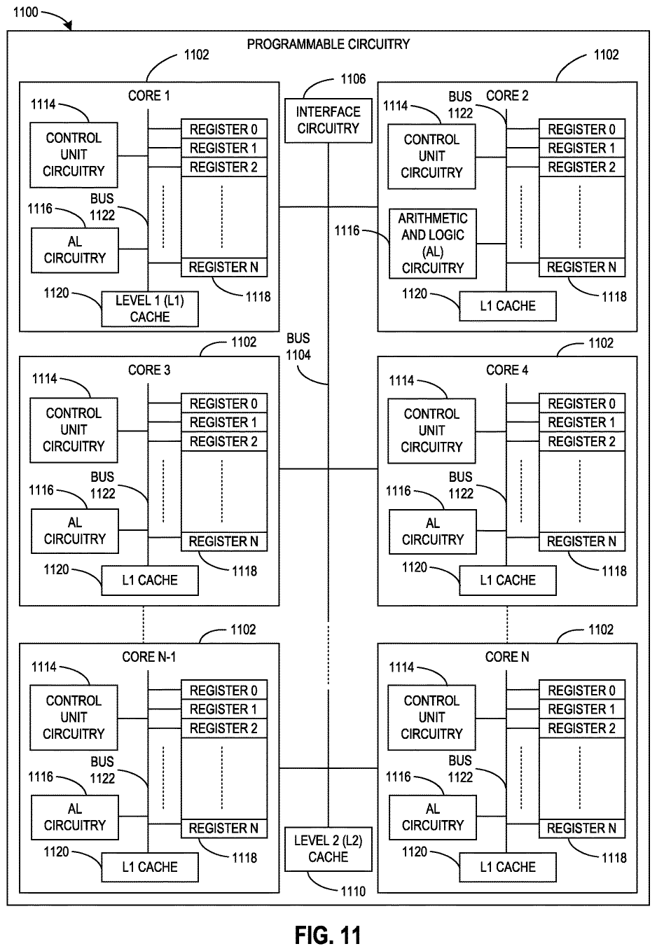

In some examples, the at least one hardware API 116 is instantiated by programmable circuitry executing interfacing instructions and/or configured to perform operations such as those represented by the flowchart(s) of FIGS. 5, 6, and 7. In some examples, the management chiplet 108 includes means for interfacing with an integrated circuit. For example, the means for interfacing may be implemented by the at least one hardware API 116. In some examples, the at least one hardware API 116 may be instantiated by programmable circuitry such as the example programmable circuitry 1012 of FIG. 10. For instance, the at least one hardware API 116 may be instantiated by the example microprocessor 1100 of FIG. 11 and/or the chiplet of FIGS. 9A and/or 9B executing machine-executable instructions such as those implemented by at least block 502 of FIG. 5, at least block 602 of FIG. 6, and/or at least blocks 702 and 712 of FIG. 7.

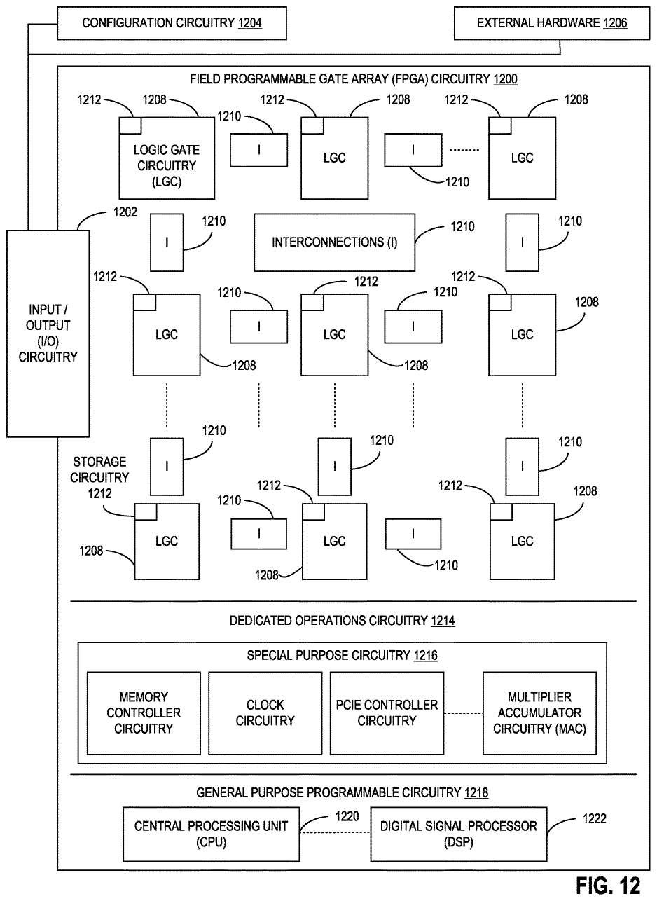

In some examples, the at least one hardware API 116 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the at least one hardware API 116 may be instantiated by any other combination of hardware, software, and/or firmware. For example, the at least one hardware API 116 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the verification circuitry 118 is instantiated by programmable circuitry executing verification instructions and/or configured to perform operations such as those represented by the flowchart(s) of FIGS. 5 and 7. In some examples, the management chiplet 108 includes means for verifying at least one of code, data, or a data provider. For example, the means for verifying may be implemented by the verification circuitry 118. In some examples, the verification circuitry 118 may be instantiated by programmable circuitry such as the example programmable circuitry 1012 of FIG. 10. For instance, the verification circuitry 118 may be instantiated by the example microprocessor 1100 of FIG. 11 and/or the chiplet of FIGS. 9A and/or 9B executing machine-executable instructions such as those implemented by at least block 504 of FIG. 5 and/or at least blocks 704, 706, and 714 of FIG. 7.

In some examples, the verification circuitry 118 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the verification circuitry 118 may be instantiated by any other combination of hardware, software, and/or firmware. For example, the verification circuitry 118 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

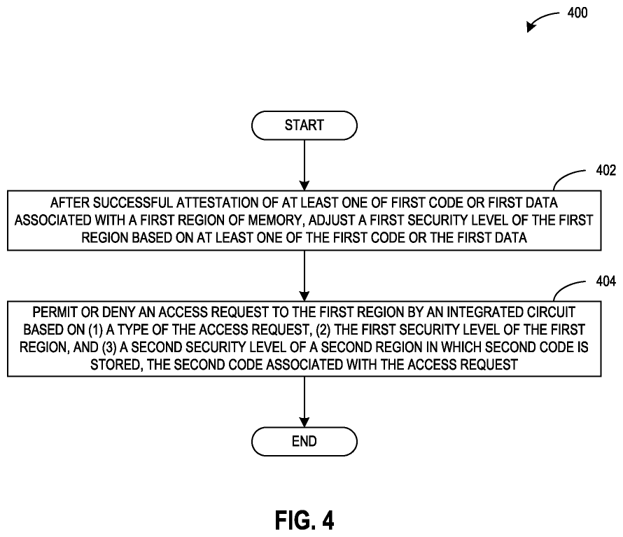

In some examples, the PMM circuitry 120 is instantiated by programmable circuitry executing physical memory management instructions and/or configured to perform operations such as those represented by the flowchart(s) of FIGS. 4, 5, 6, and 7. In some examples, the management chiplet 108 includes means for managing physical memory regions. For example, the means for managing may be implemented by the PMM circuitry 120. In some examples, the PMM circuitry 120 may be instantiated by programmable circuitry such as the example programmable circuitry 1012 of FIG. 10. For instance, the PMM circuitry 120 may be instantiated by the example microprocessor 1100 of FIG. 11 and/or the chiplet of FIGS. 9A and/or 9B executing machine-executable instructions such as those implemented by at least blocks 402 and 404 of FIG. 4, at least blocks 506, 508, and 510 of FIG. 5, at least blocks 604, 606, and 608 of FIG. 6, and/or at least blocks 708, 710, 716, 718, and 720 of FIG. 7.

In some examples, the PMM circuitry 120 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the PMM circuitry 120 may be instantiated by any other combination of hardware, software, and/or firmware. For example, the PMM circuitry 120 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

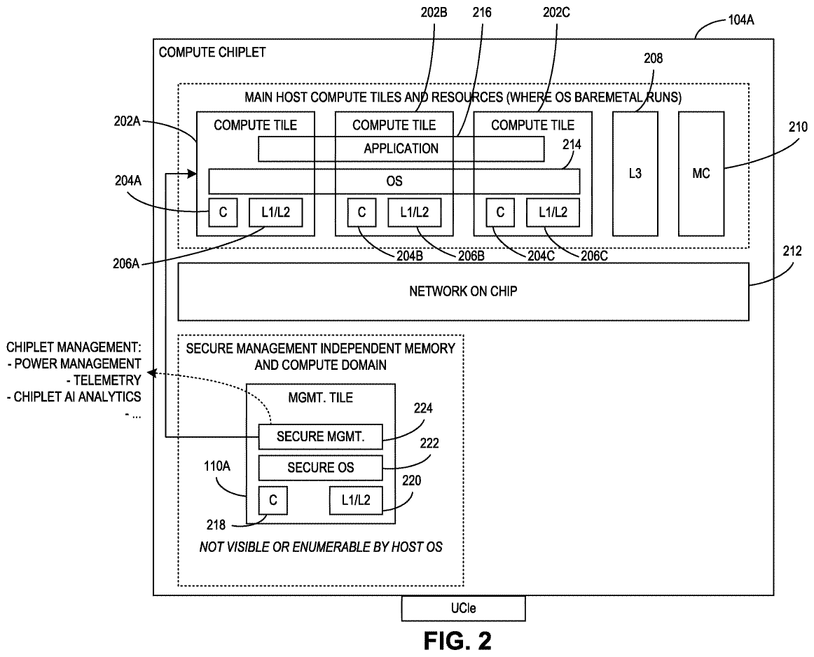

FIG. 2 is a block diagram of the example compute chiplet 104A included in the compute device 102 of FIG. 1. FIG. 2 also illustrates an example implementation of the management tile 110A included in the compute chiplet 104A. The compute chiplet 104A of FIG. 2 may be instantiated (e.g., create an instance of, bring into being for any length of time, materialize, implement, etc.) by programmable circuitry. For example, programmable circuitry may be implemented by a CPU executing first instructions, a chiplet, an array of chiplets, a PLD, a GAL device, a PAL device, a CPLD, a SPLD, a MCU, a PSoC, etc. Additionally or alternatively, the compute chiplet 104A of FIG. 2 may be instantiated (e.g., create an instance of, bring into being for any length of time, materialize, implement, etc.) by (i) an ASIC and/or (ii) an FPGA (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the compute chiplet 104A includes example compute tiles 202A-C. In the example of FIG. 2, the compute tiles 202A-C include respective example programmable circuitry 204A-C and respective example memories 206A-C. The example compute chiplet 104A also includes an example memory tile 208 and an example memory controller tile 210. In the example of FIG. 2, one or more of the memories 206A-C or the memory tile 208 stores the logical page table 114A. As described above, the logical page table 114A caches security level metadata defined by and stored in the PMM circuitry 120. In the example of FIG. 2, the compute chiplet 104A also includes an example communication tile 212 that implements an on-device network (e.g., on-chip network, NoC, etc.) coupled to the other tiles 202A-C, 208 and 210 to permit the tiles to communicate with each other.

In the illustrated example of FIG. 2, the compute tiles 202A-C (e.g., the respective programmable circuitry 204A-C and the respective memories 206A-C) execute an example bare metal OS 214, also referred to as an example host OS 214. The host OS 214 is accessible to example application(s) 216 executing on the compute chiplet 104A. As such, the application(s) 216 may have access to any or all of the resources provided by the compute tiles 202A-C (e.g., including the respective programmable circuitry 204A-C and respective memories 206A-C), the memory tile 208, the memory controller tile 210, and/or the communication tile 212. For example, the compute tiles 202A-C, the memory tile 208, the memory controller tile 210, and the communication tile 212 may be managed by the common OS 214 and be part of the same coherence domain.

As noted above, the example compute chiplet 104A of FIG. 2 also includes the management tile 110A. The management tile 110A includes example programmable circuitry 218 and example memory 220. The programmable circuitry 218 is distinct from the programmable circuitry 204A-C and the memory 220 is distinct from the memories 206A-C. The management tile 110A (e.g., the programmable circuitry 218 and the memory 220) executes an example secure OS 222 that is distinct from the host OS 214 of the compute chiplet 104A.

In the illustrated example of FIG. 2, the management tile 110A is independent and not enumerable or discoverable by the host OS 214 running on compute chiplet 104A. Therefore, the management tile 110A is isolated from access by the host OS 214. In some examples, the management tile 110A has independent address and compute spaces such that the management tile 110A is not reachable from another tile in the compute chiplet 104A. For example, the programmable circuitry 204A-C and the memories 206A-C of the compute tiles 202A-C may be associated with a common address space (e.g., that is part of the same coherence domain), whereas the programmable circuitry 218 and the memory 220 of the management tile 110A may be associated with another address space that is distinct from that common address space.

In some examples, the management tile 110A provides a secure communication path, which can be network-based, based on a memory address shared space, etc., with other secure management agents in the compute device 102 containing the compute chiplet 104A. For example, the management tile 110A may provide a secure communication path with the management chiplet 108 in the compute device 102. In some examples, the communication path is based on authentication to limit access to trusted management agents, such as the management chiplet 108.

In some examples, the management tile 110A is included in the TPM flow of the compute device 102 and/or the system 100, which permits the management tile 110A to check and verify the integrity of the management tile 110A itself and/or other tiles in the compute chiplet 104A. For example, the management tile 110A can utilize the TPM flow to verify the integrity of the hardware, firmware, and/or software of the management tile 110A to detect any unauthorized and/or improper changes. Additionally or alternatively, in some examples, the management tile 110A can utilize the TPM flow to verify the integrity of the hardware, firmware and/or software of the other tile(s) in the compute chiplet 104A that the management tile 110A is responsible for managing to detect any unauthorized and/or improper changes associated with those tile(s).

In the illustrated example of FIG. 2, the management tile 110A executes example secure management software 224 on top of its secure management OS 222. The secure management software 224 provides a set of observability and management/control APIs, such as those described above, to permit control of feature(s) of the tile(s) included in the compute chiplet 104A and/or to permit observation of state(s) of the tile(s) included in the compute chiplet 104A. For example, the APIs can perform power management associated with the programmable circuitry 204A-C of the compute tiles 202A-C, perform memory management associated with the memory circuitry 206A-C of the compute tiles 202A-C and/or the memory tile 208, obtain telemetry from one or more of the tiles 202A-C, 208, 210, and/or 212, support AI analytics associated with the compute chiplet 104A. etc. In some examples, the secure management software 224 has a higher privilege level (e.g., kernel-level privileges) to permit access to the circuitry of the compute tiles 202A-C. In some examples, the management tile 110A authenticates the secure management software 224 before execution of the secure management software 224 is initiated and prevents execution if authentication of the secure management software 224 is unsuccessful.

In the illustrated example of FIG. 2, the programmable circuitry 218 implements an instance of the at least one hardware API 116, the verification circuitry 118, and the PMM circuitry 120 to enforce security on the compute chiplet 104A. For example, the verification circuitry 118 can verify code and/or data that is to be or is stored in the memory circuitry 206A-C and/or the memory tile 208 as described above. Additionally, for example, the PMM circuitry 120 can manage security levels of code and/or data that is to be or is stored in the memory circuitry 206A-C and/or the memory tile 208 as described above. In some examples, the management tile 110A and/or components thereof (e.g., the at least one hardware API 116, the verification circuitry 118, and the PMM circuitry 120) are implemented at the communication tile 212. For example, the communication tile 212 includes the functionality of the management tile 110A in such examples.

In the illustrated example FIG. 2, the secure management software 224 of the management tile 110A provides trusted management agent(s) in other parts of the compute device 102, such as the management chiplet 108, with access to the APIs, or a subset thereof. In some examples, access to the management tile 110A is limited to trusted management agents within the boundaries of the compute device 102 including the compute chiplet 104A. In some such examples, the external access to the management tile 110A is limited to the management chiplet 108, and access originating from other external sources is blocked.

In examples disclosed herein, the management chiplet 108 is implemented similarly to the compute chiplet 104A. For example, the at least one hardware API 116, the verification circuitry 118, and the PMM circuitry 120 are implemented as tiles that are in communication via an example communication tile such as the communication tile 212. In such an example, the verification circuitry 118 and the PMM circuitry 120 are implemented on tiles including programmable circuitry such as the programmable circuitry 218. Additionally, in such an example, the verification circuitry 118 and the PMM circuitry 120 are independent and not enumerable or discoverable by the host OS 214 running on compute chiplets 104A-B other than via the at least one hardware API 116. Therefore, the verification circuitry 118 and the PMM circuitry 120 are isolated from access by the host OS 214 as described above. In some examples, the at least one hardware API 116 provides a secure communication path, which can be network-based, based on a memory address shared space, etc., with other secure management agents in the compute device 102 containing the compute chiplet 104A such as the management tile 110A.

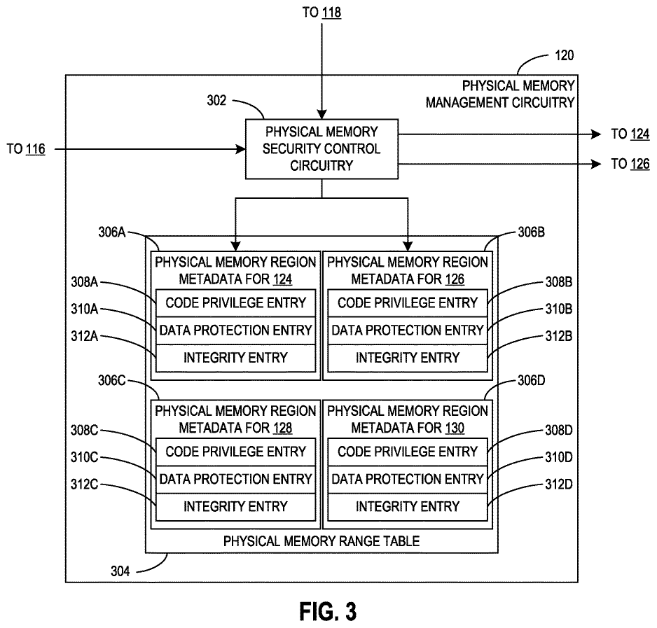

FIG. 3 is a block diagram of an example implementation of the PMM circuitry 120 of FIG. 1. The PMM circuitry 120 of FIG. 3 may be instantiated (e.g., create an instance of, bring into being for any length of time, materialize, implement, etc.) by programmable circuitry. For example, programmable circuitry may be implemented by a CPU executing first instructions, a chiplet, an array of chiplets, a PLD, a GAL device, a PAL device, a CPLD, a SPLD, an MCU, a PSoC, etc. Additionally or alternatively, the PMM circuitry 120 of FIG. 3 may be instantiated (e.g., create an instance of, bring into being for any length of time, materialize, implement, etc.) by (i) an ASIC and/or (ii) an FPGA (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the illustrated example of FIG. 3, the PMM circuitry 120 includes example physical memory security control circuitry 302 and an example physical memory region table 304. In the example of FIG. 3, the physical memory security control circuitry 302 is in communication with the at least one hardware API 116, the verification circuitry 118, and the physical memory region table 304. Additionally, the physical memory security control circuitry 302 is in communication with the physical memory 106 and verifies memory access requests from the compute chiplets 104A-B and/or the data provider 132. In the example of FIG. 3, the physical memory region table 304 stores example physical memory region metadata 306A-D that specifies respective security levels of code and/or data stored in regions of the physical memory 106. For example, example first physical memory region metadata 306A specifies the security level of code stored in the first physical memory region 124, example second physical memory region metadata 306B specifies the security level of data stored in the second physical memory region 126, example third physical memory region metadata 306C specifies the security level of code stored in the third physical memory region 128, and example fourth physical memory region metadata 306D specifies the security level of data stored in the fourth physical memory region 130.

In the illustrated example of FIG. 3, the physical memory region metadata 306A-D includes example respective code privilege entries 308A-D, example respective data protection entries 310A-D, and example respective integrity entries 312A-D. For example, the code privilege entries 308A-B specify, reference, provide, identify, or otherwise indicate a privilege level of code stored in a region of the physical memory 106. Example privilege levels include user, system service, driver, kernel or supervisor, hypervisor, and system management. For example, a user privilege level entity (e.g., a process, code, an application, etc.) is permitted to make system calls to the OS of a compute device but cannot access hardware of the compute device. A system service privilege level entity (e.g., a user-level library, a service framework, an I/O manager, middleware, etc.) is, for example, permitted to access system resources of a compute device but cannot control hardware of the compute device or alter kernel structures.

Also, for example, a driver privilege level entity (e.g., a driver, a low-level system service, etc.) is, for example, permitted more access than a system service entity but cannot directly access hardware of a compute device or execute all privileged instructions such as kernels. A kernel privilege level entity (e.g., a kernel, etc.) is, for example, permitted to fully access all hardware, memory, and instructions on a compute device except for hypervisor privilege level entities, system management privilege level entities, and management components such as the management chiplet 108 and the management tiles 110A-B. Also, for example, a hypervisor privilege level entity (e.g., a hypervisor) is permitted to control and isolate multiple OSes (including respective kernel-level entities), but cannot interfere with or access system management privilege level entities or management components such as the management chiplet 108 and the management tiles 110A-B.

A system management privilege level entity (e.g., firmware, BIOS, hardware control code, etc.) is, for example, permitted to perform highly secure operations isolated from kernel and hypervisor level entities, but cannot perform general-purpose computing, manage system-wide resources, or access management components such as the management chiplet 108 and the management tiles 110A-B. Modern compute devices typically do not utilize driver or system service privilege levels and instead utilize the user privilege level instead for purposes of simplicity. Examples disclosed herein also include a management privilege level that is assigned to management components such as the management chiplet 108 and the management tiles 110A-B and/or components thereof. In general, the management privilege level is higher than the system management privilege level which is higher than the hypervisor privilege level. Additionally, the hypervisor privilege level is higher than the kernel privilege level which is higher than driver privilege level. The driver privilege level is higher than system service privilege level which is higher than user privilege level. More generally, code can be referred to as being privileged (e.g., system management, hypervisor, kernel) or unprivileged (e.g., user).

In the illustrated example of FIG. 3, the data protection entries 310A-D specify, reference, provide, identify, or otherwise indicate a protection level of data stored in a region of the physical memory 106. Example protection levels include unprotected, restricted, and protected. In general, the protected protection level provides more protection than the restricted protection level which provides more protection than the unprotected protection level. Protection levels may also be referred to based on a standard or data governance policy implemented on a compute device. For example, if a National Institute of Standards and Technology (NIST) standard is utilized, protection levels may include low, moderate, and high (in ascending order of protection) as described in the NIST standard. Additionally or alternatively, if the International Organization for Standardization (ISO) 27001 standard is utilized, protection levels may be classified based on confidentiality, integrity, and availability (CIA) as described in the ISO 27001 standard. Example protection levels in a data governance policy include public, internal, confidential, and top secret (in ascending order of protection). More generally, data can be referred to as being protected (e.g., internal, confidential, restricted) or unprotected (e.g., public).

In the illustrated example of FIG. 3, the integrity entries 312A-D specify, reference, provide, identify, or otherwise indicate an integrity level of code and/or data stored in a region of the physical memory 106. Example integrity levels include verified (also referred to as trusted), unverified (also referred to as untrusted), intermediate (also referred to as error), partial trust (also referred to as degraded trust), and quarantined state. For example, a verified integrity level indicates that proof-of-identity (e.g., a certificate, a signature, etc.) provided for attestation matches an expected state. Also, for example, an unverified integrity level indicates that proof-of-identity provided for attestation does not match an expected state. An intermediate integrity level indicates, for example, that attestation could not be completed (e.g., due to network issues, corrupt data, verification failure, etc.) and therefore proof-of-identity could not be confirmed. Also, for example, a partial trust integrity level indicates that proof-of-identity provided for attestation partially matches an expected state but does not fully match or cannot be fully matched to the expected state. A quarantined state integrity level indicates, for example, that attestation produced uncertain results.

In the illustrated example of FIG. 3, an example first code privilege entry 308A stores a privilege level of unprivileged (e.g., user-level). In the example of FIG. 3, an example first data protection entry 310A stores a value associated with the first physical memory region 124. For example, as the first physical memory region 124 does not store data, the first data protection entry 310A stores a null value. In some examples, the first data protection entry 310A stores a protection level for code stored in the first physical memory region 124. For example, code (which is also data) stored in the first physical memory region 124 may be assigned a protection level (e.g., public) depending on the level of confidentiality attributed to the code. In the example of FIG. 3, an example first integrity entry 312A stores an integrity level of unverified.

In the illustrated example of FIG. 3, an example second code privilege entry 308B stores a value associated with the second physical memory region 126. For example, as the second physical memory region 126 does not store code, the second code privilege entry 308B stores a null value. In some examples, the second code privilege entry 308B stores a privilege level for code stored in the second physical memory region 126. For example, the data stored in the second physical memory region 126 may represent code that is assigned a privilege level (e.g., unprivileged or user-level). In the example of FIG. 3, an example second data protection entry 310B stores a protection level of unprotected (e.g., public). Also, an example second integrity entry 312B stores an integrity level of unverified.

In the illustrated example of FIG. 3, an example third code privilege entry 308C stores a privilege level of privileged (e.g., kernel-level). In the example of FIG. 3, an example third data protection entry 310C stores a value associated with the third physical memory region 128. For example, as the third physical memory region 128 does not store data, the third data protection entry 310C stores a null value. In some examples, the third data protection entry 310C stores a protection level for code stored in the third physical memory region 128. For example, code (which is also data) stored in the third physical memory region 128 may be assigned a protection level (e.g., internal, confidential, restricted, etc.) depending on the level of confidentiality attributed to the code. In the example of FIG. 3, an example third integrity entry 312C stores an integrity level of verified.

In the illustrated example of FIG. 3, an example fourth code privilege entry 308D stores a value associated with the fourth physical memory region 130. For example, as the fourth physical memory region 130 does not store code, the fourth code privilege entry 308D stores a null value. In some examples, the fourth code privilege entry 308D stores a privilege level for code stored in the fourth physical memory region 130. For example, the data stored in the fourth physical memory region 130 may represent code that is assigned a privilege level (e.g., privileged or kernel-level). In the example of FIG. 3, an example fourth data protection entry 310D stores a protection level of protected (e.g., internal, confidential, restricted, etc.). Also, an example fourth integrity entry 312D stores an integrity level of verified.

In the illustrated example of FIG. 3, the physical memory security control circuitry 302 manages the physical memory region metadata 306A-D. For example, based on the verification circuitry 118 successfully attesting at least one of code that is stored in or data that is or is to be stored in a region of the physical memory 106, the physical memory security control circuitry 302 adjusts a security level of the region of the physical memory 106. For example, the physical memory security control circuitry 302 adjusts the physical memory region metadata corresponding to the physical memory region in the physical memory region table. As described above, in some examples, attestation includes the verification circuitry 118 verifying the legitimacy of a data provider such as the data provider 132. If the verification circuitry 118 does not successfully attest the at least one of the code or the data (or in some examples, the data provider), the physical memory security control circuitry 302 generates a general protection fault.

In the illustrated example of FIG. 3, the physical memory security control circuitry 302 adjusts a security level of the region of the physical memory 106 based on at least one of code or data that is or is to be stored in a physical memory region. For example, based on the verification results and sensitivity information included in the at least one of the code or the data, the physical memory security control circuitry 302 adjusts the security level as described herein. As described above, example privilege levels, example protection levels, and example attestation levels are discrete levels that the physical memory security control circuitry 302 can change between based on at least one of code or data that is or is to be stored in a physical memory region. In some examples, security levels are on a dynamic, sliding scale and the physical memory security control circuitry 302 can adjust the security level of at least one of code or data by adjusting the security level along the sliding scale. For example, security levels are dispersed along a very fine-grained scale (e.g., from zero to 100) and the physical memory security control circuitry 302 can adjust the security level of at least one of code or data by adjusting the security level anywhere along the very fine-grained scale (e.g., anywhere from zero to 100). In some examples, the physical memory security control circuitry 302 can select a security level for at least one of code or data based on the at least one of code or data.

In the illustrated example of FIG. 3, the physical memory security control circuitry 302 enforces security on the compute device 102 based on the physical memory region metadata 306A-D stored in the physical memory region table 304. For example, based on an access request from a compute chiplet for a physical memory region, the physical memory security control circuitry 302 determines whether code executed by the compute chiplet and associated with the access request has a privilege level that satisfies a protection level of data stored in the physical memory region. In the example of FIG. 3, the physical memory security control circuitry 302 references the physical memory region metadata stored in the physical memory region table 304 to determine whether the privilege level of the code satisfies the protection level of the data.

In the illustrated example of FIG. 3, if the physical memory security control circuitry 302 determines that the code has a privilege level that satisfies the protection level of the data, the physical memory security control circuitry 302 permits the access request. If the physical memory security control circuitry 302 determines that the code does not have a privilege level that satisfies the protection level of the data, the physical memory security control circuitry 302 denies the compute code from accessing the physical memory region. In this manner, the physical memory security control circuitry 302 enforces security on the compute device 102 based on the physical memory region metadata 306A-D stored in the physical memory region table 304.

In the illustrated example of FIG. 3, the physical memory region table 304 is implemented by a volatile memory (e.g., a static random access memory (SRAM), SDRAM, DRAM, RDRAM, etc.) and/or a non-volatile memory (e.g., read-only memory (ROM), flash memory, etc.). While in the illustrated example the physical memory region table 304 is illustrated as a single memory, the physical memory region table 304 may be implemented by multiple memories. For example, the physical memory region table 304 may be a memory chiplet that includes one or more memory tiles. In additional or alternative examples, the physical memory region table 304 may be implemented by any number and/or type(s) of memories.

In some examples, the physical memory security control circuitry 302 is instantiated by programmable circuitry executing physical memory security control instructions and/or configured to perform operations such as those represented by the flowchart(s) of FIGS. 4, 5, 6, and 7. In some examples, the PMM circuitry 120 includes means for controlling security of physical memory. For example, the means for controlling may be implemented by the physical memory security control circuitry 302. In some examples, the physical memory security control circuitry 302 may be instantiated by programmable circuitry such as the example programmable circuitry 1012 of FIG. 10. For instance, the physical memory security control circuitry 302 may be instantiated by the example microprocessor 1100 of FIG. 11 and/or the chiplet of FIGS. 9A and/or 9B executing machine-executable instructions such as those implemented by at least blocks 402 and 404 of FIG. 4, at least blocks 506, 508, and 510 of FIG. 5, at least blocks 604, 606, and 608 of FIG. 6, and/or at least blocks 708, 710, 716, 718, and 720 of FIG. 7.

In some examples, the physical memory security control circuitry 302 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the physical memory security control circuitry 302 may be instantiated by any other combination of hardware, software, and/or firmware. For example, the physical memory security control circuitry 302 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the management chiplet 108 of FIG. 1 is illustrated in FIG. 1, one or more of the elements, processes, and/or devices illustrated in FIG. 1 may be combined, divided, re-arranged, omitted, eliminated, and/or implemented in any other way. Additionally, while an example manner of implementing the PMM circuitry 120 of FIG. 1 is illustrated in FIG. 3, one or more of the elements, processes, and/or devices illustrated in FIG. 3 may be combined, divided, re-arranged, omitted, eliminated, and/or implemented in any other way. Further, the example at least one hardware API 116, the example verification circuitry 118, the example physical memory security control circuitry 302, the example physical memory region table 304, and/or more generally, the example PMM circuitry 120, and/or, more generally, the example management chiplet 108 of FIG. 1, may be implemented by hardware alone or by hardware in combination with software and/or firmware. Thus, for example, any of the example at least one hardware API 116, the example verification circuitry 118, the example physical memory security control circuitry 302, the example physical memory region table 304, and/or more generally, the example PMM circuitry 120, and/or, more generally, the example management chiplet 108, could be implemented by programmable circuitry, such as one or more chiplets, one or more processor cores, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing unit(s) (VPUs), and/or field programmable logic device(s) (FPLD(s)) such as FPGAs in combination with machine-readable instructions (e.g., firmware or software). Further still, the example management chiplet 108 of FIG. 1 and/or the example PMM circuitry 120 of FIG. 3 may include one or more elements, processes, and/or devices in addition to, or instead of, those illustrated in FIGS. 1 and/or 3, and/or may include more than one of any or all of the illustrated elements, processes, and devices.

Flowchart(s) representative of example machine-readable instructions, which may be executed by programmable circuitry to implement and/or instantiate the management chiplet 108 of FIG. 1 and/or the PMM circuitry 120 of FIG. 3 and/or representative of example operations which may be performed by programmable circuitry to implement and/or instantiate the management chiplet 108 of FIG. 1 and/or the PMM circuitry 120 of FIG. 3, are shown in FIGS. 4, 5, 6, and/or 7. The machine-readable instructions may be one or more executable programs or portion(s) of one or more executable programs for execution by programmable circuitry such as the programmable circuitry 1012 shown in the example programmable circuitry platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 4, 5, 6, and/or 7, many other methods of implementing the example management chiplet 108 and/or the example PMM circuitry 120 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, chiplet(s), discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, a chiplet and/or an array of chiplets, etc.)). As used herein, programmable circuitry includes any type(s) of circuit that may be programmed to perform a desired function such as, for example, a CPU, a core, a chiplet, an arrays of chiplets, a GPU, a VPU, and/or an FPGA. The programmable circuitry may include one or more CPUs, one or more cores, one or more chiplets, one or more GPUs, one or more VPUs, and/or one or more FPGAs located in the same package (e.g., the same integrated circuit (IC) package or in two or more separate housings), one or more one or more CPUs, one or more cores, one or more chiplets, one or more GPUs, one or more VPUs, and/or one or more FPGAs in a single machine, multiple CPUs, cores, chiplets, GPUs, VPUs, and/or FPGAs distributed across multiple servers of a server rack, and/or multiple CPUs, cores, chiplets, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, Swift, etc.

As mentioned above, the example operations of FIGS. 4, 5, 6, and/or 7 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 4 is a flowchart representative of example machine-readable instructions and/or example operations 400 that may be executed, instantiated, and/or performed by programmable circuitry to implement the PMM circuitry 120 of FIGS. 1 and/or 3. The example machine-readable instructions and/or the example operations 400 of FIG. 4 begin at block 402. At block 402, after successful attestation of at least one of first code or first data associated with a first region of memory, the physical memory security control circuitry 302 adjusts a first security level of the first region based on the at least one of the first code or the first data. For example, after the verification circuitry 118 successfully attests first code stored in or first data store or to be stored in a first region of the physical memory 106, the physical memory security control circuitry 302 adjusts the physical memory region metadata (e.g., privilege level for code, protection level for data, and integrity level) of the first region to adjust security level. In some examples, the verification circuitry 118 attests first data by attesting a data provider of the first data as described above.

In the illustrated example of FIG. 4, the physical memory security control circuitry 302 adjusts the security level of the first region based on the at least one of the first code or the first data. For example, if the verification circuitry 118 verifies that first code is associated with an AI/ML model that is to process sensitive data (e.g., based on proof-of-identity included in a security level adjustment request), the physical memory security control circuitry 302 assigns an elevated privilege level to the first region, which stores the first code (e.g., a privilege level above unprivileged or user). Also, for example, if the verification circuitry 118 verifies that first data is sensitive (e.g., based on proof-of-identity included in a security level adjustment request), the physical memory security control circuitry 302 assigns an elevated protection level to the first region, which stores the first data (e.g., a protection level above unprotected or public). The foregoing are examples of how the physical memory security control circuitry 302 adjusts the security level of a region of physical memory based on at least one of code or data associated with the region.

In the illustrated example of FIG. 4, at block 404, the physical memory security control circuitry 302 permits or denies an access request to the first region by an integrated circuit based on (1) a type of the access request, (2) the first security level of the first region, and (3) a second security level of a second region in which second code is stored, the second code associated with the access request. In the example of FIG. 4, the integrated circuit is, for example, the compute chiplet 104A and/or one or more of the compute tiles(s) 112A thereof. Additionally, the second code is executed by the integrated circuit and provides the access request to the first region. For example, the second code provides the access request to the first region by at least one of generating or initiating the access request.

In the illustrated example of FIG. 4, the second code generates the access request when the second code creates the access request and transmits the access request to the physical memory security control circuitry 302 via the at least one hardware API 116. In some examples, the second code initiates the access request. For example, the second code triggers a process that results in the physical memory security control circuitry 302 receiving the access request. In some examples, the memory that includes the first region also includes the second region. In additional or alternative examples, the second region is included in a different memory than the memory that includes the first region.

In the illustrated example of FIG. 4, the physical memory security control circuitry 302 evaluates the memory access operation access(o, k, l): bool to determine if the memory access operation returns true. For example, the physical memory security control circuitry 302 determines, for the type of operation (o) (e.g., read, write, execute, etc.), whether a privilege level (k) assigned to the second region (which stores the second code) satisfies a protection level (l) assigned to the first region (which stores the at least one of the first code or the first data). If the memory access operation returns false, the physical memory security control circuitry 302 denies the access request. If the memory access operation returns true, the physical memory security control circuitry 302 permits the access request. The foregoing are examples of how the physical memory security control circuitry 302 permits or denies an access request to a first region of physical memory based on (1) a type of the access request, (2) a first security level of the first region, and (3) a second security level of a second region in which second code is stored, the second code associated with the access request.

FIG. 5 is a flowchart representative of example machine-readable instructions and/or example operations 500 that may be executed, instantiated, and/or performed by programmable circuitry to process a security level adjustment request. The example machine-readable instructions and/or the example operations 500 of FIG. 5 begin at block 502, at which the at least one hardware API 116 receives a security level adjustment request for a region of memory. For example, the security level adjustment request is from one of the chiplets 104A-B to adjust a security level associated with a region of the physical memory 106. In some examples, the security level adjustment request is from the data provider 132.

In the illustrated example of FIG. 5, at block 504, the verification circuitry 118 determines whether at least one of code or data associated with the region has been attested. For example, the verification circuitry 118 determines whether at least one of code that is stored in or data that is or is to be stored in the region has been attested. In some examples, the verification circuitry 118 attests data by attesting a data provider of the data as described above. Based on whether the at least one of the code or the data has been attested, the PMM circuitry 120 (e.g., the physical memory security control circuitry 302) determines whether to adjust a security level of the region.

For example, based on (e.g., in response to) the verification circuitry 118 determining that the at least one of the code or the data has not been attested (block 504: NO), the PMM circuitry 120 (e.g., the physical memory security control circuitry 302) determines not to adjust the security level of the region and the machine-readable instructions and/or the operations 500 proceed to block 506. At block 506, the PMM circuitry 120 (e.g., the physical memory security control circuitry 302) generates a general protection fault. Based on (e.g., in response to) the verification circuitry 118 determining that the at least one of the code or the data has been attested (block 504: YES), the PMM circuitry 120 (e.g., the physical memory security control circuitry 302) determines to adjust the security level of the region and the machine-readable instructions and/or the operations 500 proceed to block 508.

In the illustrated example of FIG. 5, at block 508, the PMM circuitry 120 (e.g., the physical memory security control circuitry 302) adjusts a security level of the region based on the at least one of the code or the data. For example, if the verification circuitry 118 verifies that code is associated with an AI/ML model that is to process sensitive data (e.g., based on proof-of-identity included in the security level adjustment request), the PMM circuitry 120 (e.g., the physical memory security control circuitry 302) assigns an elevated privilege level to the region that stores the code (e.g., a privilege level above unprivileged or user). Also, for example, if the verification circuitry 118 verifies that data is sensitive (e.g., based on proof-of-identity included in the security level adjustment request), the PMM circuitry 120 (e.g., the physical memory security control circuitry 302) assigns an elevated protection level to the region that stores the data (e.g., a protection level above unprotected or public).

In the illustrated example of FIG. 5, at block 510, the PMM circuitry 120 loads a cache of a compute chiplet with a copy of metadata specifying the security level. For example, the physical memory security control circuitry 302 causes storage of a copy of the metadata specifying the security level in one or more of the logical page tables 114A-B of one or more of the compute chiplets 104A-B. By caching a copy of the metadata (e.g., privilege levels, protection levels, and/or integrity levels of physical memory ranges) at the logical page tables 114A-B, examples disclosed herein accelerate permissions and/or privilege checks. For example, when executing read and/or write memory access operations, the MMUs of the compute chiplets 104A-B verify privileges of executed code against protections of accessed data before virtual-to-physical address translation (e.g., when paging is enabled). As described above, the metadata is provided to the logical page tables 114A-B by the PMM circuitry 120 and cannot be changed by the compute chiplets 104A-B even though the metadata is cached there. For example, code running in the compute chiplets 104A-B can only trigger or request changes to the metadata using the at least one hardware API 116 after verification by the verification circuitry 118.

FIG. 6 is a flowchart representative of example machine-readable instructions and/or example operations 600 that may be executed, instantiated, and/or performed by programmable circuitry to process a memory access request. The example machine-readable instructions and/or the example operations 600 of FIG. 6 begin at block 602, at which the at least one hardware API 116 receives an access request from a compute chiplet executing code. In the example of FIG. 6, the access request is for a region of memory. For example, the memory is the physical memory 106. At block 604, the PMM circuitry 120 (e.g., the physical memory security control circuitry 302) determines whether, for the type of the access request, the code has a privilege level that satisfies a protection level of data stored in the region.

Based on (e.g., in response to) the PMM circuitry 120 determining that, for the type of the access request, the code has a privilege level that satisfies a protection level of data stored in the region (block 604: YES), the machine-readable instructions and/or the operations 600 proceed to block 606. At block 606, the PMM circuitry 120 (e.g., the physical memory security control circuitry 302) permits the compute chiplet to access the region. Based on (e.g., in response to) the PMM circuitry 120 determining that, for the type of the access request, the code does not have a privilege level that satisfies a protection level of data stored in the region (block 604: NO), the machine-readable instructions and/or the operations 600 proceed to block 608. At block 608, the PMM circuitry 120 (e.g., the physical memory security control circuitry 302) denies the compute chiplet from accessing the region.

FIG. 7 is a flowchart representative of example machine-readable instructions and/or example operations 700 that may be executed, instantiated, and/or performed by programmable circuitry to configure one or more AI/ML models to process sensitive data and allocate protected memory to store the sensitive data. For example, the compute chiplet 104A executes an AI application such as Tensorflow, Pytorch, or Keras from which the compute chiplet 104A can launch one or more AI models. In such an example, the compute chiplet 104A deserializes an AI model from storage and loads the AI model into an unprotected and unprivileged region of the physical memory 106 (e.g., the second physical memory region 126) using unprivileged code (e.g., stored in the first physical memory region 124). For example, the AI model deserialized from storage includes code for the AI model and parameters (e.g., hyperparameters, one or more weight matrices, one or more weight tensors, etc.) for the AI model. To upgrade the security level of the AI model, the AI application, via the compute chiplet 104A, transmits a security level adjustment request to the at least one hardware API 116. For example, the security level adjustment request is forwarded to the at least one hardware API 116 by the OS and firmware of the compute chiplet 104A.

In the illustrated example of FIG. 7, the machine-readable instructions and/or the operations 700 begin at block 702, at which the at least one hardware API 116 receives a first security level adjustment request for an AI model loaded into a first region of memory. For example, the first region is unprotected and unprivileged. In the example of FIG. 7, the management chiplet 108 receives the first security level adjustment request from an AI application executed by the compute chiplet 104A via a first one of the at least one hardware API 116. Based on receiving the first security level adjustment request, the at least one hardware API 116 forwards the first security level adjustment request to the verification circuitry 118. In the example of FIG. 7, at block 704, the verification circuitry 118 accesses an attestation service with a signature of the AI model. For example, the signature is included in the first security level adjustment request.

In the illustrated example of FIG. 7, the first security level adjustment request includes metadata associated with the AI model. In some examples, the verification circuitry 118 accesses the first region to access the metadata. For example, the verification circuitry 118 has direct access to the memory (e.g., the physical memory 106). In the example of FIG. 7, the AI model includes metadata that (1) specifies sensitivity information about the AI model and (2) includes a signature provided by a trusted authority (e.g., an attestation service, a certificate authority, etc.). In the example of FIG. 7, the sensitivity information specifies what type (e.g., the protection level) of data the AI model is to access and what type (e.g., the protection level) of data the AI model is to generate. For example, the sensitivity information specifies that the AI model is to access sensitive data (e.g., images including depictions of people and animals where the faces and/or other sensitive information of the people are not obscured) and that the AI model is to generate non-sensitive data (e.g., a classification of what type of animal is depicted in an image).

In the illustrated example of FIG. 7, the verification circuitry 118 utilizes the metadata (e.g., the signature) to populate an attestation request to the attestation service. As described above, in some examples, the verification circuitry 118 includes a secure enclave. For example, the verification circuitry 118 utilizes the secure enclave to communicate with an external attestation service to verify whether the AI model is legitimate. In the example of FIG. 7, at block 706, the verification circuitry 118 determines whether the AI model has been attested. Based on the response from the attestation service, the verification circuitry 118 indicates to the PMM circuitry 120 whether the AI model has been attested. Based on (e.g., in response to) the verification circuitry 118 determining that the AI model has not been attested (block 706: NO), the machine-readable instructions and/or the operations 700 proceed to block 716. Based on (e.g., in response to) the verification circuitry 118 determining that the AI model has been attested (block 706: YES), the machine-readable instructions and/or the operations 700 proceed to block 708.

In the illustrated example of FIG. 7, at block 708, based on the AI model, the PMM circuitry 120 adjusts a first security level of the first region to protected, privileged, and verified. For example, based on the sensitivity information included in the metadata of the AI model as well as successful attestation, the physical memory security control circuitry 302 adjusts the first security level of the first region to protected, privileged, and verified. In the example of FIG. 7, at block 710, the PMM circuitry 120 loads a cache of a compute chiplet with a copy of first metadata specifying the first security level. For example, the physical memory security control circuitry 302 causes storage of a copy of the first metadata specifying the first security level in the logical page table 114A of the compute chiplet 104A. As described above, the AI application executed by the compute chiplet 104A loads an AI model (e.g., code and parameters for the AI model) into the first region, and then establishes the AI model as protected, privileged, and verified depending on attestation results.

In the illustrated example of FIG. 7, at block 712, the at least one hardware API 116 receives a second security level adjustment request for a second region of the memory. For example, the second region is unprotected. In the example of FIG. 7, the management chiplet 108 receives the second security level adjustment request from the AI application executed by the compute chiplet 104A via a second one of the at least one hardware API 116. Additionally, in the example of FIG. 7, the second region is to store sensitive data to be processed by the AI model (e.g., in the first region and is now privileged) as well as intermediate activations of the AI model. Based on receiving the second security level adjustment request, the at least one hardware API 116 forwards the second security level adjustment request to the verification circuitry 118. At block 714, the verification circuitry 118 determines whether a data provider that is to cause storage of data in the second region has been attested. For example, the verification circuitry 118 accesses a signature included in metadata of the data provider to perform attestation.

Based on the result of attestation, the verification circuitry 118 indicates to the PMM circuitry 120 whether the data provider has been attested. Based on (e.g., in response to) the verification circuitry 118 determining that the data provider has not been attested (block 714: NO), the machine-readable instructions and/or the operations 700 proceed to block 716. At block 716, the PMM circuitry 120 (e.g., the physical memory security control circuitry 302) generates a general protection fault. Based on (e.g., in response to) the verification circuitry 118 determining that the data provider has been attested (block 714: YES), the machine-readable instructions and/or the operations 700 proceed to block 718. At block 718, the PMM circuitry 120 adjusts a second security level of the second region to protected and verified. For example, based on the sensitivity information included in the metadata of the data provider as well as successful attestation, the physical memory security control circuitry 302 adjusts the second security level of the second region to protected and verified.

In the illustrated example of FIG. 7, at block 720, the PMM circuitry 120 loads the cache of the compute chiplet with a copy of second metadata specifying the second security level. For example, the physical memory security control circuitry 302 causes storage of a copy of the second metadata specifying the second security level in the logical page table 114A of the compute chiplet 104A. In some examples, the physical memory security control circuitry 302 also causes storage of a copy of the second metadata in a cache of the IOMM circuitry 136. Additionally or alternatively, the IOMM circuitry 136 accesses the PMM circuitry 120 to determine the second metadata. Based on the second region being established as protected and verified, the AI application executed by the compute chiplet 104A can initiate a DMA request (e.g., via one of the at least one hardware API 116) to establish a connection between the data provider and the second region. In this manner, the data provider (e.g., the data provider 132) can provide sensitive data to the protected region of the memory (e.g., the second region) via DMA circuitry (e.g., the DMA circuitry 134) as verified by IOMM circuitry (e.g., the IOMM circuitry 136). For example, the IOMM circuitry 136 checks the contents of the PMM circuitry 120 to validate that an address provided by the data provider 132 (via the DMA circuitry 134) is in a region of the memory that includes sufficient protections to store sensitive data.

As described above, the first region storing the AI model has a first security level of protected, privileged, and verified and the second region storing sensitive data to be processed by AI model has a second security level of protected and verified. Based on the first region and the second region being established as described above, the AI application executed by the compute chiplet 104A branches execution to code for the AI model. As such, the AI model may perform one or more inferences on data stored in the second region. Because the first region storing the code is privileged, the privilege level of the compute chiplet 104A is elevated to the same level as the first region when execution is branched to the code for the AI model. Thus, the compute chiplet 104A is permitted to execute a load operation to load parameters of the AI model from the first region.

Additionally, because the privilege level of the compute chiplet 104A is elevated as described above, the compute chiplet 104A is permitted to execute a load operation to load sensitive data captured by the data provider from the second region. As described above, the compute chiplet 104A is to store intermediate activations for the AI model in the second region. Because the privilege level of the compute chiplet 104A is elevated, the compute chiplet 104A is also permitted to store the intermediate activations (e.g., generated during an inference) in the second region and is permitted to load the intermediate activations from the second region. After completing an inference operation with the AI model, the compute chiplet 104A stores the output (e.g., a classification of what type of animal is depicted in an image) in an unprotected region of the memory. For example, the output from the AI model may be stored in an unprotected region of the memory because the output is non-sensitive as described above. Based on execution of the AI model completing, the AI model executed by the compute chiplet 104A branches execution back to the AI application which returns the privilege level of the compute chiplet 104A to unprivileged.

As described above, the example machine-readable instructions and/or the example operations 700 of FIG. 7 may be executed, instantiated, and/or performed by programmable circuitry to configure one or more AI/ML models to process sensitive data and allocate protected memory to store the sensitive data. For example, to facilitate safe execution of an AI/ML model that processes sensitive data and generates non-sensitive data, the example machine-readable instructions and/or the example operations 700 establishes three regions of memory. For example, the example machine-readable instructions and/or the example operations 700 establish an unprotected (e.g., data) region to store the AI/ML model after deserialization from storage (e.g., a hard drive). The unprotected region may be updated to protected and/or privileged (e.g., data and code) after the AI/ML model has been attested. The example machine-readable instructions and/or the example operations 700 also establish a protected (e.g., data) region to store intermediate activations of the AI/ML model and sensitive data captured by a sensor and to be processed by the AI/ML model. Additionally, the example machine-readable instructions and/or the example operations 700 establish an unprotected (e.g., data) region to store the non-sensitive data output by the AI/ML model for downstream consumption.

While the example of FIG. 7 is described with reference to one AI/ML model launched by an AI/ML application, it should be understood that multiple AI/ML models may be launched by the same AI/ML application. For example, if an AI application is associated with two memory regions storing two different AI models, respectively, the AI application may load and execute both AI models distinctly from one another. That is, after verification of each AI model by the verification circuitry 118, the PMM circuitry 120 adjusts a first security level of a first memory region associated with a first AI model to permit the first AI model to access the first memory region and deny a second AI model from accessing the first memory region. Additionally, the PMM circuitry 120 adjust a second security level of a second memory region associated with the second AI model to permit the second AI model to access the second memory region and deny the first AI model from accessing the second memory region. In this manner, each AI model can access its own data but cannot access the data of the other AI model despite both AI models being associated with (e.g., launched from) the same AI application. As such, examples disclosed herein enforce different access policies for different memory regions accessible to the same user application.

FIGS. 8, 9A, 9B, and 10 include example computing architectures in which any of the techniques and configurations above may be implemented.

FIG. 8 illustrates an example hardware arrangement of an example data center 800 used to provide multiple examples or instances of a computing system (e.g., the programmable circuitry platform 1000, described below), with each example of the computing system identified as a respective platform (e.g., the platform 830, described below). The data center 800 includes example data center infrastructure 801, an example data center network fabric 802, and an example power distribution unit 803 to support multiple racks of compute platforms, with a single instance of an example rack 810 depicted. The data center infrastructure 801 may provide physical components that host the compute platform hardware, storage components, and/or networking equipment. The data center network fabric 802 may include switches and/or networking components to support data flows among various compute platforms and storage devices throughout the data center. The power distribution unit 803 may include components to distribute and/or control power among the various compute platforms, networking, and storage devices.

The rack 810 of FIG. 8 includes, but is not limited to, example cooling infrastructure 811, an example network interface 812, and/or other related physical components to support discrete instances of multiple chassis. The rack 810 provides power, connectivity, and/or cooling to each of the multiple chassis in a single rack, with a single instance of a chassis 820 in the example of FIG. 8. The chassis 820 includes, but is not limited to, example cooling infrastructure 821, an example chassis network fabric 822, and an example power supply 823, which provides cooling, network connectivity, and/or power to multiple platforms within the chassis. Although a single instance of an example platform 830 is illustrated in FIG. 8, in some examples, a common data center rack configuration may include dozens of chassis, with each chassis to support a number of platforms depending on the physical size of the platform hardware and/or supporting equipment.

The platform 830 of FIG. 8 may be referred to as a server or node, depending on the use case for the platform 830 and the data center 800. The platform 830 includes but is not limited to examples of a discrete computing system hosted on a single board. In FIG. 8, the platform 830 is illustrated as hosting a first example chip assembly 840A and a second example chip assembly 840B on a first board provided by a printed circuitry board (PCB) or other platform board, shown as an example PCB 831. In some examples, the platform 830 may include only one chip package, whereas the PCB 831 includes interconnection of multiple chip assemblies via an interface (e.g., a peripheral component interconnect express (PCIe) interface). Additional chip packages and components may also be hosted on the PCB 831.

Some examples of the chip assembly 840A, 840B of FIG. 8 may be termed as a System-on-Chip (SoC) package, as modular chiplets that perform different functions are integrated into a single package-even though this chip package is composed of multiple dies unlike a traditional SoC design that uses a single die. Other examples of the chip assembly 840A, 840B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 840A and the second chip assembly 840B of FIG. 8 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 840A of FIG. 8 includes a I/O Hub chiplet 841, chiplets 842, and a power supply 843. These components may be hosted on an interposer that is designed to connect multiple dies and/or components within a single semiconductor package (e.g., chip package). In some examples, the chiplets 842 may be manufactured and/or sourced separately and later assembled into the chip package to create the chip assembly 840A. Various connections may be provided among the chiplets 842, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

FIG. 9A illustrates an example arrangement of an example chip assembly 940A (e.g., a multi-processing core example of the first chip assembly 840A or the second chip assembly 840B of FIG. 8), with expanded views of the chiplets and processing units included herein. In FIG. 9A the chip assembly 940A, which may constitute a SoC, SoP, SiP, and/or other type of chip package, includes chiplets such as an example chiplet 910A, an example chiplet 910B, etc. and associated on-package memory (e.g., high-speed memory) such as 3D-stacked, High Bandwidth Memory (HBM) instances (shown as an example HBM 920A, an example HBM 920B, interfaces (e.g., UCIe interfaces) shown as an example UCIe 921A, an example UCIe 921B, and an example I/O hub 930 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 910A, 910B of FIG. 9A include multiple processing units and the example processing units 900A, 900B, 900C, 900D include one or multiple cores, respectively. For example, the chiplet 910A of FIG. 9A includes four processing units (the processing units 900A, 900B, 900C, 900D) and an example Level 3 (L3) cache 904. The processing units 900A, 900B, 900C, 900D may include one or multiple processing cores, one or multiple caches, other processing units and/or passive and/or active elements. For example, processing unit 900A includes two cores (an example core 901A and an example core 901B), vector processing unit 902, and an example level 2 (L2) cache 903. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 9B is an example arrangement of an example chip assembly 940B (e.g., a multi-chiplet high-performance computing (HPC) example of chip assembly 840A, 840B), adapted for HPC applications (e.g., parallel processing operations involving thousands, millions, or more of processors and/or cores operating simultaneously). The example chip assembly 940B illustrates placement as a SiP, SoC, and/or other package onto a platform board (e.g., the PCB 831 of FIG. 8). The platform board may be in a data center (e.g., the data center 800 of FIG. 8) or in a standalone deployment setting (e.g., in a standalone computer system, mobile computing device, autonomous device, etc.).

The chip assembly 940B of FIG. 9B is composed of multiple chiplets, shown with four chiplets, including example chiplets 910C, 910D, 910E, 910F. The chiplets 910C, 910D, 910E, 910F include multiple processing units, such as thirty two processing units with a corresponding level 3 (L3) cache for each processing unit. The processing units may include one or multiple cores, such as an example single-core processing unit 900E shown as part of the chiplet 910C. The chip assembly 940B also includes corresponding memory resources, such as HBM elements corresponding to respective banks of processing units (e.g., HBM 920B and HBM 920C corresponding respective sets of processing units of chiplet 910C), UCIe interfaces, and/or an I/O Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 900, the chiplet 910, the chip 840, and/or the platform 830 of FIGS. 8, 9A, and/or 9B) to perform operations described above for electronic systems or devices (e.g., to perform operations such as those represented by the flowchart(s) of FIGS. 4, 5, 6, and/or 7, etc.). It should be further understood that software, including one or more machine-readable instructions, that facilitates processing and operations as described above may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

FIG. 10 is a block diagram of an example programmable circuitry platform 1000 structured to execute and/or instantiate the example machine-readable instructions and/or the example operations of FIGS. 4, 5, 6, and/or 7 to implement the PMM circuitry 120 of FIG. 3 and/or the management chiplet 108 of FIG. 1. The programmable circuitry platform 1000 can be, for example, a server, a personal computer, a workstation, a self-learning machine, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, chiplets, cores, FPGAs, microprocessors, CPUs, GPUS, VPUs, DSPs, and/or microcontrollers from any desired family or manufacturer. In some examples, the programmable circuitry 1012 can be implemented by RISC-V architecture and/or a chiplet (e.g., the chiplet assemblies 840A, 840B, 940A, 940B of FIGS. 9, 10A and/or 10B). The programmable circuitry 1012 may be implemented by one or more semiconductor based (e.g., silicon based) devices. In this example, the programmable circuitry 1012 implements the example at least one hardware API 116, the example verification circuitry 118, the example physical memory security control circuitry 302, the example physical memory region table 304, and/or, more generally, the example PMM circuitry 120, and/or, more generally, the example management chiplet 108.

In some examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of first circuitry at one point in time and reused by a second circuit in the first circuitry, or by a third circuit in a second circuitry at a different time.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1020 may include an output interface, such as an interface connected to a display device, an input interface such as an interface connected to an alphanumeric input device or a user interface (UI) navigation device, or a communication interface. In some examples, a connected I/O device may also include a display device, an alphanumeric input device, and/or a navigation device that is integrated into a single unit, such as a touch screen display. The communication interface may provide a connection with a network interface device used to transmit and/or receive electronic signals on the network 1026. The programmable circuitry platform 1000 may also include other interfaces or hardware in connection with a signal generation device (e.g., an audio or radio signal generation device), an output controller (e.g., for connection with a serial, universal serial bus (USB), parallel, and/or other wired or wireless connection such as which uses via infrared (IR) and/or near field communication (NFC) technologies), an input controller (e.g., for connection with sensors or peripheral devices), etc.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1032, which may be implemented by the machine-readable instructions of FIGS. 4, 5, 6, and/or 7, may be stored in the mass storage device 1028, in the volatile memory 1014, in the non-volatile memory 1016, and/or on at least one non-transitory computer-readable storage medium such as a CD or DVD which may be removable. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1032.

The instructions 1032 may reside, during execution and/or other operation of the programmable circuitry platform 1000, completely, or at least partially, within the volatile memory 1014, within non-volatile memory 1016, within the local memory 1013, within a removable storage, within a non-removable storage, and/or within the programmable circuitry 1012. Thus, any combination of the programmable circuitry 1012, the volatile memory 1014, the non-volatile memory 1016, the local memory 1013, and/or a storage device of the removable storage or non-removable storage may constitute a machine-readable medium or media. The instructions 1032, when loaded and executed by the programmable circuitry 1012, may invoke or utilize a defined instruction set 1032 of the programmable circuitry 1012, such as a processor instruction set defined by an instruction set architecture (ISA) of a reduced instruction set computer (RISC) or complex instruction set computer (CISC) architecture including but not limited to the RISC-V instruction set provided in a RISC-V architecture. A RISC-V architecture and instruction set is one of several available architectures and instruction sets that may be used in examples of the compute components (e.g., the programmable circuitry 1012) described herein.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 4, 5, 6, and/or 7 to effectively instantiate the circuitry of FIGS. 1-3 as logic circuits to perform operations corresponding to those machine-readable instructions. In some such examples, the circuitry of FIGS. 1-3 is instantiated by the hardware circuits of the microprocessor 1100 in combination with the machine-readable instructions. For example, the microprocessor 1100 may be implemented by multi-core hardware circuitry such as a CPU, a DSP, a GPU, a VPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowcharts of FIGS. 4, 5, 6, and/or 7.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry 1116 (sometimes referred to as an ALU), a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowchart(s) of FIGS. 4, 5, 6, and/or 7 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 4, 5, 6, and/or 7. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4, 5, 6, and/or 7. As such, the FPGA circuitry 1200 may be configured and/or structured to effectively instantiate some or all of the operations/functions corresponding to the machine-readable instructions of the flowchart(s) of FIGS. 4, 5, 6, and/or 7 as dedicated logic circuits to perform the operations/functions corresponding to those software instructions in a dedicated manner analogous to an ASIC. Therefore, the FPGA circuitry 1200 may perform the operations/functions corresponding to the some or all of the machine-readable instructions of FIGS. 4, 5, 6, and/or 7 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine-readable instructions of FIGS. 4, 5, 6, and/or 7 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine-readable instructions represented by the flowchart(s) of FIGS. 4, 5, 6, and/or 7 to perform first operation(s)/function(s), the FPGA circuitry 1200 of FIG. 12 may be configured and/or structured to perform second operation(s)/function(s) corresponding to a second portion of the machine-readable instructions represented by the flowcharts of FIGS. 4, 5, 6, and/or 7, and/or an ASIC may be configured and/or structured to perform third operation(s)/function(s) corresponding to a third portion of the machine-readable instructions represented by the flowcharts of FIGS. 4, 5, 6, and/or 7.

It should be understood that some or all of the circuitry of FIGS. 1-3 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 1-3 may be instantiated, for example, in one or more threads executing concurrently and/or in series. For example, the microprocessor 1100 of FIG. 11 may execute machine-readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 1-3 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

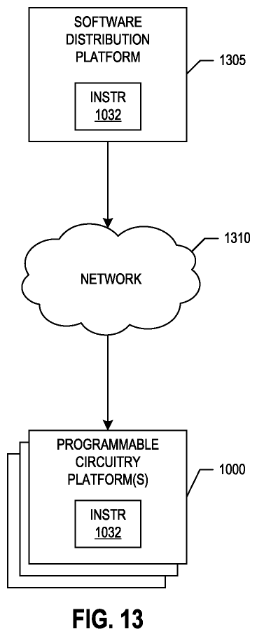

A block diagram illustrating an example software distribution platform 1305 to distribute software such as the example machine-readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine-readable instructions of FIGS. 4, 5, 6, and/or 7, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine-readable instructions of FIGS. 4, 5, 6, and/or 7, may be downloaded to the example programmable circuitry platform 1000, which is to execute the machine-readable instructions 1032 to implement the example PMM circuitry 120 and/or the example management chiplet 108. In some examples, one or more servers of the software distribution platform 1305 periodically offer, transmit, and/or force updates to the software (e.g., the example machine-readable instructions 1032 of FIG. 10) to ensure improvements, patches, updates, etc., are distributed and applied to the software at the end user devices. Although referred to as software above, the distributed “software” could alternatively be firmware.

The instructions 1032 may be transmitted or received over the network 1310 using a transmission medium via the interface circuitry 1020 of FIG. 10 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 802.11 family of standards known as Wi-Fi®), IEEE 802.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B. Also, as used herein, the phrase “based on” is intended to convey that a first thing is in some way dependent on or results from a second thing. For example, the phrase “perform A based on B” implies that A is in some way dependent on or results from B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, chiplets that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enforce security through physical memory regions. For example, disclosed systems, apparatus, articles of manufacture, and methods include a management chiplet or management tile that operates as an external entity to verify requested security level changes before adjusting the protections, privileges, and/or integrity of data and/or code in a compute device. As such, examples disclosed herein do not permit the core processor (e.g., one or more compute chiplets as described in FIG. 1) and/or any software and/or firmware executed by the core processor to directly control physical memory protections, privileges, and/or integrity.

Accordingly, example systems, apparatus, articles of manufacture, and methods have been disclosed that improve data and/or code security of compute devices. Disclosed systems, apparatus, articles of manufacture, and methods improve the efficiency of using a computing device by maintaining security on the computing device, even in the event that security of a core processor and/or any software and/or firmware executed by the core processor is compromised. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to enforce security through physical memory regions are disclosed herein. Further examples and combinations thereof include the following:

Example 1 includes an apparatus comprising memory including at least one region, a first integrated circuit (IC) coupled to the memory, and a second IC coupled to the memory, the first IC to after successful attestation of at least one of first code or first data associated with a first region of the memory, adjust a first security level of the first region based on the at least one of the first code or the first data, and permit or deny an access request to the first region by the second IC based on (1) a type of the access request, (2) the first security level of the first region, and (3) a second security level of a second region in which second code is stored, the second code associated with the access request.

Example 2 includes the apparatus of example 1, wherein the memory is first memory, the first IC includes second memory, the second IC includes a cache, and the first IC is to cause storage of metadata in the second memory, the metadata to specify the first security level of the first region, and cause storage of a copy of the metadata in the cache.

Example 3 includes the apparatus of any of examples 1 or 2, wherein the first code is associated with a first artificial intelligence (AI) model, the memory includes the first region and a third region, the first region and the third region are associated with an AI application, the first region is associated with the first AI model, the third region is associated with a second AI model, the first AI model and the second AI model are associated with the AI application, and the first IC is to adjust the first security level of the first region to permit the first AI model to access the first region and deny the second AI model from accessing the first region, and adjust a third security level of the third region to permit the second AI model to access the third region and deny the first AI model from accessing the third region.

Example 4 includes the apparatus of example 3, wherein the first region does not overlap with the third region.

Example 5 includes the apparatus of any of examples 1, 2, 3, or 4, wherein the memory includes the second region, and the first IC is to, after successful attestation of the second code, adjust the second security level of the second region based on the second code.

Example 6 includes the apparatus of any of examples 1, 2, 3, 4, or 5, wherein the first IC is to based on a security level adjustment request for the first region, determine whether the at least one of the first code or the first data associated with the first region has been attested, and based on whether the at least one of the first code or the first data has been attested, determine whether to adjust the first security level of the first region.

Example 7 includes the apparatus of example 6, wherein the first IC is to, based on the at least one of the first code or the first data having not been attested, generate a general protection fault.

Example 8 includes the apparatus of any of examples 1, 2, 3, 4, 5, 6, or 7, wherein the at least one of the first code or the first data is associated with metadata that specifies the first security level, the metadata including at least one of a privilege level of the first code or a protection level of the first data, and an integrity level of the at least one of the first code or the first data.

Example 9 includes the apparatus of any of examples 1, 2, 3, 4, 5, 6, 7, or 8, wherein the first IC and the second IC are at least one of chiplets that are interconnected via an input/output hub or tiles that are interconnected via a network on-chip.

Example 10 includes the apparatus of any of examples 1, 2, 3, 4, 5, 6, 7, 8, or 9, wherein the second IC is to utilize the second code to provide the access request.

Example 11 includes the apparatus of any of examples 1, 2, 3, 4, 5, 6, 7, 8, 9, or 10, wherein the at least one of the first code or the first data is at least one of stored in or to be stored in the first region, respectively.

Example 12 includes the apparatus of any of examples 1, 2, 3, 4, 5, 6, 7, 8, 9, 10, or 11, wherein the first IC is to access an attestation server to perform attestation of the at least one of the first code or the first data.

Example 13 includes a computer-readable medium comprising instructions to cause at least one programmable circuit of a first integrated circuit (IC) to after successful attestation of at least one of first code or first data associated with a first region of memory, adjust a first security level of the first region based on the at least one of the first code or the first data, and permit or deny an access request to the first region by a second IC based on (1) a type of the access request, (2) the first security level of the first region, and (3) a second security level of a second region in which second code is stored, the second code associated with the access request.

Example 14 includes the computer-readable medium of example 13, wherein the memory is first memory, the first IC includes second memory, the second IC includes a cache, and one or more of the at least one programmable circuit is to cause storage of metadata in the second memory, the metadata to specify the first security level of the first region, and cause storage of a copy of the metadata in the cache.

Example 15 includes the computer-readable medium of any of examples 13 or 14, wherein the first code is associated with a first artificial intelligence (AI) model, the memory includes the first region and a third region, the first region and the third region are associated with an AI application, the first region is associated with the first AI model, the third region is associated with a second AI model, the first AI model and the second AI model are associated with the AI application, and one or more of the at least one programmable circuit is to adjust the first security level of the first region to permit the first AI model to access the first region and deny the second AI model from accessing the first region, and adjust a third security level of the third region to permit the second AI model to access the third region and deny the first AI model from accessing the third region.

Example 16 includes the computer-readable medium of example 15, wherein the first region does not overlap with the third region.

Example 17 includes the computer-readable medium of any of examples 13, 14, 15, or 16, wherein the memory includes the second region, and one or more of the at least one programmable circuit is to, after successful attestation of the second code, adjust the second security level of the second region based on the second code.

Example 18 includes the computer-readable medium of any of examples 13, 14, 15, 16, or 17, wherein one or more of the at least one programmable circuit is to based on a security level adjustment request for the first region, determine whether the at least one of the first code or the first data associated with the first region has been attested, and based on whether the at least one of the first code or the first data has been attested, determine whether to adjust the first security level of the first region.

Example 19 includes the computer-readable medium of example 18, wherein one or more of the at least one programmable circuit is to, based on the at least one of the first code or the first data having not been attested, generate a general protection fault.

Example 20 includes the computer-readable medium of any of examples 13, 14, 15, 16, 17, 18, or 19, wherein the at least one of the first code or the first data is associated with metadata that specifies the first security level, the metadata including at least one of a privilege level of the first code or a protection level of the first data, and an integrity level of the at least one of the first code or the first data.

Example 21 includes the computer-readable medium of any of examples 13, 14, 15, 16, 17, 18, 19, or 20, wherein the first IC and the second IC are at least one of chiplets that are interconnected via an input/output hub or tiles that are interconnected via a network on-chip.

Example 22 includes the computer-readable medium of any of examples 13, 14, 15, 16, 17, 18, 19, 20, or 21, wherein the second IC is to utilize the second code to provide the access request.

Example 23 includes the computer-readable medium of any of examples 13, 14, 15, 16, 17, 18, 19, 20, 21, or 22, wherein the at least one of the first code or the first data is at least one of stored in or to be stored in the first region, respectively.

Example 24 includes the computer-readable medium of any of examples 13, 14, 15, 16, 17, 18, 19, 20, 21, 22, or 23, wherein one or more of the at least one programmable circuit is to access an attestation server to perform attestation of the at least one of the first code or the first data.

Example 25 includes an apparatus comprising memory including at least one region, an integrated circuit (IC) coupled to the memory, and means for managing memory regions, the means for managing coupled to the memory, the means for managing to after successful attestation of at least one of first code or first data associated with a first region of the memory, adjust a first security level of the first region based on the at least one of the first code or the first data, and permit or deny an access request to the first region by the IC based on (1) a type of the access request, (2) the first security level of the first region, and (3) a second security level of a second region in which second code is stored, the second code associated with the access request.

Example 26 includes the apparatus of example 25, wherein the memory is first memory, the IC includes a cache, and the means for managing is to cause storage of metadata in second memory associated with the means for managing, the metadata to specify the first security level of the first region, and cause storage of a copy of the metadata in the cache.

Example 27 includes the apparatus of any of examples 25 or 26, wherein the first code is associated with a first artificial intelligence (AI) model, the memory includes the first region and a third region, the first region and the third region are associated with an AI application, the first region is associated with the first AI model, the third region is associated with a second AI model, the first AI model and the second AI model are associated with the AI application, and the means for managing is to adjust the first security level of the first region to permit the first AI model to access the first region and deny the second AI model from accessing the first region, and adjust a third security level of the third region to permit the second AI model to access the third region and deny the first AI model from accessing the third region.

Example 28 includes the apparatus of example 27, wherein the first region does not overlap with the third region.

Example 29 includes the apparatus of any of examples 25, 26, 27, or 28, wherein the memory includes the second region, and the means for managing is to, after successful attestation of the second code, adjust the second security level of the second region based on the second code.

Example 30 includes the apparatus of any of examples 25, 26, 27, 28, or 29, wherein the apparatus includes means for verifying the at least one of the first code or the first data, the means for verifying to, based on a security level adjustment request for the first region, determine whether the at least one of the first code or the first data associated with the first region has been attested, and the means for managing is to, based on whether the at least one of the first code or the first data has been attested, determine whether to adjust the first security level of the first region.

Example 31 includes the apparatus of example 30, wherein the means for managing is to, based on the at least one of the first code or the first data having not been attested, generate a general protection fault.

Example 32 includes the apparatus of any of examples 25, 26, 27, 28, 29, 30, or 31, wherein the at least one of the first code or the first data is associated with metadata that specifies the first security level, the metadata including at least one of a privilege level of the first code or a protection level of the first data, and an integrity level of the at least one of the first code or the first data.

Example 33 includes the apparatus of any of examples 25, 26, 27, 28, 29, 30, 31, or 32, wherein the IC is at least one of a first chiplet interconnected with a second chiplet via an input/output hub or a first tile interconnected with a second tile via a network on-chip.

Example 34 includes the apparatus of any of examples 25, 26, 27, 28, 29, 30, 31, 32, or 33, wherein the IC is to utilize the second code to provide the access request.

Example 35 includes the apparatus of any of examples 25, 26, 27, 28, 29, 30, 31, 32, 33, or 34, wherein the at least one of the first code or the first data is at least one of stored in or to be stored in the first region, respectively.

Example 36 includes the apparatus of any of examples 25, 26, 27, 28, 29, 30, 31, 32, 33, 34, or 35, including means for verifying the at least one of the first code or the first data, the means for verifying to access an attestation server to perform attestation of the at least one of the first code or the first data.

Example 37 includes a method comprising after successful attestation of at least one of first code or first data associated with a first region of memory, adjusting, by executing an instruction with at least one programmable circuit of a first integrated circuit (IC), a first security level of the first region based on the at least one of the first code or the first data, and permitting or denying, by executing an instruction with one or more of the at least one programmable circuit, an access request to the first region by a second IC based on (1) a type of the access request, (2) the first security level of the first region, and (3) a second security level of a second region in which second code is stored, the second code associated with the access request.

Example 38 includes the method of example 37, wherein the memory is first memory, the first IC includes second memory, the second IC includes a cache, and the method includes causing storage of metadata in the second memory, the metadata to specify the first security level of the first region, and causing storage of a copy of the metadata in the cache.

Example 39 includes the method of any of examples 37 or 38, wherein the first code is associated with a first artificial intelligence (AI) model, the memory includes the first region and a third region, the first region and the third region are associated with an AI application, the first region is associated with the first AI model, the third region is associated with a second AI model, the first AI model and the second AI model are associated with the AI application, and the method includes adjusting the first security level of the first region to permit the first AI model to access the first region and deny the second AI model from accessing the first region, and adjusting a third security level of the third region to permit the second AI model to access the third region and deny the first AI model from accessing the third region.

Example 40 includes the method of example 39, wherein the first region does not overlap with the third region.

Example 41 includes the method of any of examples 37, 38, 39, or 40, wherein the memory includes the second region, and the method includes, after successful attestation of the second code, adjusting the second security level of the second region based on the second code.

Example 42 includes the method of any of examples 37, 38, 39, 40, or 41, including receiving a notification including an attestation result for the at least one of the first code or the first data, based on a security level adjustment request for the first region, determining whether the attestation result indicates that the at least one of the first code or the first data associated with the first region has been attested, and based on whether the at least one of the first code or the first data has been attested, determining whether to adjust the first security level of the first region.

Example 43 includes the method of example 42, including, based on the attestation result indicating that the at least one of the first code or the first data has not been attested, generating a general protection fault.

Example 44 includes the method of any of examples 37, 38, 39, 40, 41, 42, or 43, wherein the at least one of the first code or the first data is associated with metadata that specifies the first security level, the metadata including at least one of a privilege level of the first code or a protection level of the first data, and an integrity level of the at least one of the first code or the first data.

Example 45 includes the method of any of examples 37, 38, 39, 40, 41, 42, 43, or 44, wherein the first IC and the second IC are at least one of chiplets that are interconnected via an input/output hub or tiles that are interconnected via a network on-chip.

Example 46 includes the method of any of examples 37, 38, 39, 40, 41, 42, 43, 44, or 45, including utilizing, with the second IC, the second code to provide the access request.

Example 47 includes the method of any of examples 37, 38, 39, 40, 41, 42, 43, 44, 45, or 46, wherein the at least one of the first code or the first data is at least one of stored in or to be stored in the first region, respectively.

Example 48 includes the method of any of examples 37, 38, 39, 40, 41, 42, 43, 44, 45, 46, or 47, including accessing an attestation server to perform attestation of the at least one of the first code or the first data.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
memory including at least one region;
a first integrated circuit (IC) coupled to the memory; and
a second IC coupled to the memory, the first IC to:
after successful attestation of at least one of code or data associated with a first region of the memory, adjust a security level of the first region based on the at least one of the code or the data; and
permit or deny an access request to the first region by the second IC.

2. The apparatus of claim 1, wherein the memory is first memory, the first IC includes second memory, the second IC includes a cache, and the first IC is to:
cause storage of metadata in the second memory, the metadata to specify the security level of the first region; and
cause storage of a copy of the metadata in the cache.

3. The apparatus of claim 1, wherein the security level of the first region is a first security level, the code is associated with a first artificial intelligence (AI) model, the memory includes the first region and a second region, the first region and the second region are associated with an AI framework, the first region is associated with the first AI model, the second region is associated with a second AI model, the first AI model and the second AI model are associated with the AI framework, and the first IC is to:
adjust the first security level of the first region to permit the first AI model to access the first region and deny the second AI model from accessing the first region; and
adjust a second security level of the second region to permit the second AI model to access the second region and deny the first AI model from accessing the second region.

4. The apparatus of claim 3, wherein the first region does not overlap with the second region.

5. The apparatus of claim 1, wherein the security level of the first region is a first security level, the memory includes a second region, and the first IC is to, after successful attestation of second code stored in the second region, adjust a second security level of the second region based on the second code.

6. The apparatus of claim 1, wherein the first IC is to:
after a time period, downgrade the security level of the first region to a default security level;
based on a security level adjustment request for the first region, determine whether the at least one of the code or the data associated with the first region has been attested; and
based on whether the at least one of the code or the data has been attested, determine whether to adjust the security level of the first region.

7. The apparatus of claim 6, wherein the first IC is to, based on the at least one of the code or the data having not been attested, generate a general protection fault.

8. The apparatus of claim 1, wherein the at least one of the code or the data is associated with metadata that specifies the security level, the metadata including:
at least one of a privilege level of the code or a protection level of the data; and
an integrity level of the at least one of the code or the data.

9. The apparatus of claim 1, wherein the first IC and the second IC are at least one of chiplets or tiles that are interconnected.

10. The apparatus of claim 1, wherein the second IC is to utilize second code to provide the access request.

11. The apparatus of claim 1, wherein the at least one of the code or the data is at least one of (1) stored in or (2) to be stored in the first region.

12. The apparatus of claim 1, wherein the first IC is to access an attestation server, the attestation server to perform attestation of the at least one of the code or the data.

13. A computer-readable medium comprising instructions to cause at least one programmable circuit of a first integrated circuit (IC) to:
after successful attestation of at least one of code or data associated with a first region of memory, adjust a security level of the first region based on the at least one of the code or the data; and
permit or deny an access request to the first region by a second IC.

14. The computer-readable medium of claim 13, wherein the memory is first memory, the first IC includes second memory, the second IC includes a cache, and one or more of the at least one programmable circuit is to:
cause storage of metadata in the second memory, the metadata to specify the security level of the first region; and
cause storage of a copy of the metadata in the cache.

15. The computer-readable medium of claim 13, wherein the security level of the first region is a first security level, the code is associated with a first artificial intelligence (AI) model, the memory includes the first region and a second region, the first region and the second region are associated with an AI framework, the first region is associated with the first AI model, the second region is associated with a second AI model, the first AI model and the second AI model are associated with the AI framework, and one or more of the at least one programmable circuit is to:
adjust the first security level of the first region to permit the first AI model to access the first region and deny the second AI model from accessing the first region; and
adjust a second security level of the second region to permit the second AI model to access the second region and deny the first AI model from accessing the second region.

16. The computer-readable medium of claim 15, wherein the first region does not overlap with the second region.

17. The computer-readable medium of claim 13, wherein the security level of the first region is a first security level, the memory includes a second region, and one or more of the at least one programmable circuit is to, after successful attestation of second code stored in the second region, adjust a second security level of the second region based on the second code.

18. The computer-readable medium of claim 13, wherein one or more of the at least one programmable circuit is to:
after a time period, downgrade the security level of the first region to a default security level;
based on a security level adjustment request for the first region, determine whether the at least one of the code or the data associated with the first region has been attested; and
based on whether the at least one of the code or the data has been attested, determine whether to adjust the security level of the first region.

19. The computer-readable medium of claim 18, wherein one or more of the at least one programmable circuit is to, based on the at least one of the code or the data having not been attested, generate a general protection fault.

20. (canceled)

21. The computer-readable medium of claim 13, wherein the first IC and the second IC are at least one of chiplets or tiles that are interconnected.

22-23. (canceled)

24. The computer-readable medium of claim 13, wherein one or more of the at least one programmable circuit is to access an attestation server, the attestation server to perform attestation of the at least one of the code or the data.

25. An apparatus comprising:
memory including at least one region;
an integrated circuit (IC) coupled to the memory; and
means for managing memory regions, the means for managing coupled to the memory, the means for managing to:
after successful attestation of at least one of code or data associated with a first region of the memory, adjust a security level of the first region based on the at least one of the code or the data; and
permit or deny an access request to the first region by the IC.

26. The apparatus of claim 25, wherein the memory is first memory, the IC includes a cache, and the means for managing is to:
cause storage of metadata in second memory associated with the means for managing, the metadata to specify the security level of the first region; and
cause storage of a copy of the metadata in the cache.

27. The apparatus of claim 25, wherein the security level of the first region is a first security level, the code is associated with a first artificial intelligence (AI) model, the memory includes the first region and a second region, the first region and the second region are associated with an AI framework, the first region is associated with the first AI model, the second region is associated with a second AI model, the first AI model and the second AI model are associated with the AI framework, and the means for managing is to:
adjust the first security level of the first region to permit the first AI model to access the first region and deny the second AI model from accessing the first region; and
adjust a second security level of the second region to permit the second AI model to access the second region and deny the first AI model from accessing the second region.

28. The apparatus of claim 27, wherein the first region does not overlap with the second region.

29. The apparatus of claim 25, wherein the security level of the first region is a first security level, the memory includes a second region, and the means for managing is to, after successful attestation of second code stored in the second region, adjust a second security level of the second region based on the second code.

30. The apparatus of claim 25, wherein:
the means for managing is to, after a time period, downgrade the security level of the first region to a default security level;
the apparatus includes means for verifying the at least one of the code or the data, the means for verifying to, based on a security level adjustment request for the first region, determine whether the at least one of the code or the data associated with the first region has been attested; and
the means for managing is to, based on whether the at least one of the code or the data has been attested, determine whether to adjust the security level of the first region.

31. The apparatus of claim 30, wherein the means for managing is to, based on the at least one of the code or the data having not been attested, generate a general protection fault.

32. (canceled)

33. The apparatus of claim 25, wherein the IC is at least one of a first chiplet or a first tile interconnected with a second chiplet or a second tile, respectively.

34-35. (canceled)

36. The apparatus of claim 25, including means for verifying the at least one of the code or the data, the means for verifying to access an attestation server, the attestation server to perform attestation of the at least one of the code or the data.

37-48. (canceled)

49. The apparatus of claim 1, wherein the code is first code and the data is second code.

50. The apparatus of claim 1, wherein the security level of the first region is a first security level, and the first IC is to permit or deny the access request to the first region by the second IC based on at least one of (1) a type of the access request, (2) the first security level of the first region, or (3) a second security level of a second region in which second code is stored, the second code associated with the access request.

51. The apparatus of claim 3, wherein the code corresponds to the first AI model, the first region and the second region are accessible by the AI framework, the first region stores the first AI model, the second region stores the second AI model, the first AI model and the second AI model are launchable via the AI framework.

52. The apparatus of claim 3, wherein the AI framework includes at least one of Tensorflow, Pytorch, or Keras.

53. The apparatus of claim 9, wherein the first IC and the second IC are chiplets that are interconnected via an input/output hub.

54. The apparatus of claim 9, wherein the first IC and the second IC are tiles that are interconnected via a network on-chip.

55. The computer-readable medium of claim 13, wherein the security level of the first region is a first security level, and one or more of the at least one programmable circuit is to permit or deny the access request to the first region by the second IC based on at least one of (1) a type of the access request, (2) the first security level of the first region, or (3) a second security level of a second region in which second code is stored, the second code associated with the access request.

56. The computer-readable medium of claim 15, wherein the AI framework includes at least one of Tensorflow, Pytorch, or Keras.

57. The apparatus of claim 25, wherein the security level of the first region is a first security level, and the means for managing is to permit or deny the access request to the first region by the IC based on at least one of (1) a type of the access request, (2) the first security level of the first region, or (3) a second security level of a second region in which second code is stored, the second code associated with the access request.

58. The apparatus of claim 27, wherein the AI framework includes at least one of Tensorflow, Pytorch, or Keras.

59. An apparatus comprising:
memory including at least one region;
a first integrated circuit (IC) coupled to the memory; and
a second IC coupled to the memory, the first IC to:
after successful attestation of at least one of code or data related to a first region of the memory, adjust a security level of the first region based on the at least one of the code or the data; and
permit or deny an access request to the first region by the second IC.

60. The apparatus of claim 59, wherein the security level of the first region is a first security level, and the first IC is to permit or deny the access request to the first region by the second IC based on at least one of (1) a type of the access request, (2) the first security level of the first region, or (3) a second security level of a second region in which second code is stored, the second code related to the access request.

61. The apparatus of claim 59, wherein the at least one of the code or the data is at least one of (1) stored in or (2) to be stored in the first region.

62. The apparatus of claim 59, wherein the memory is first memory, the first IC includes second memory, the second IC includes a cache, and the first IC is to:
cause storage of metadata in the second memory, the metadata to specify the security level of the first region; and
cause storage of a copy of the metadata in the cache.

63. The apparatus of claim 59, wherein the at least one of the code or the data is related to metadata that specifies the security level, the metadata including:
at least one of a privilege level of the code or a protection level of the data; and
an integrity level of the at least one of the code or the data.
